(19) United States
(12) Patent Application Publication
(10) Pub. No.: US 2011/0169802 A1
(43) Pub. Date: Jul. 14, 2011

(54) Signal processing apparatus, display apparatus, electronic apparatus, signal processing method and program

(75) Inventors: Junichi Yamashita, Tokyo (JP); Hiroshi Hasegawa, Kanagawa (JP); Kazuo Nakamura, Kanagawa (JP); Tetsuro Yamamoto, Kanagawa (JP); Katsuhide Uchino, Kanagawa (JP)

(73) Assignee: Sony Corporation, Tokyo (JP)

(21) Appl. No.: 12/929,007

(22) Filed: Dec. 22, 2010

(30) Foreign Application Priority Data
Jan. 13, 2010 (JP) 2010-004603

(51) Int. Cl. G09G 5/00

(52) U.S. Cl. 345/211

(57) ABSTRACT

A signal processing apparatus including a conversion efficiency degradation value calculation section adapted to calculate a conversion efficiency degradation value regarding degradation of a conversion efficiency when driving current supplied to a light emitting element in each of a plurality of pixel circuits is converted into a luminance based on information regarding degradation of the conversion efficiency produced in response to lapse of light emission time of the light emitting element; a current amount degradation value calculation section adapted to calculate a current amount degradation value regarding degradation of the driving current based on information regarding degradation of the driving current produced in response to lapse of the light emission time of the light emitting element; and a correction section adapted to correct a gradation value of an image signal to be inputted to the pixel circuit based on the conversion efficiency degradation value and the current amount degradation value.

### BACKGROUND OF THE INVENTION

1. Field of the Invention

This invention relates to a signal processing apparatus, and more particularly to a signal processing apparatus, a display apparatus, an electronic apparatus, a signal processing method and a program for causing a computer to execute the signal processing method, by which ghosting is corrected.

2. Description of the Related Art

In recent years, development of a display apparatus of the flat self-luminous type which uses an organic EL (electroluminescence) element as a light emitting element thereof has been and is being carried out energetically. Since the organic EL element represents a gradation by varying the emitted light amount in response to image data of a display target, the degree of degradation of the organic EL element differs among different ones of pixel circuits which configure a display screen of a display apparatus. Since the degree of degradation differs among different pixel circuits in this manner, as time passes, some pixels on the display screen suffer comparatively much from degradation while some other pixels suffer comparatively little from degradation. In the case where pixels suffering much from degradation and pixels suffering little from degradation exist in a mixed state on the display screen in this manner, the pixels suffering much from degradation become darker than surrounding pixels. This gives rise to a phenomenon that an image having been displayed immediately before then looks remaining, called ghosting phenomenon.

A display apparatus having a function of preventing such ghosting has been proposed and is disclosed, for example, in Japanese Patent Laid-Open No. 2008-176274, particularly in FIG. 1 (hereinafter referred to as Patent Document 1). In the display apparatus of Patent Document 1, within a period within which the display apparatus is not used, degradation of a light emitting element the degree of degradation of which is comparatively low is promoted so that it becomes equal to the degree of degradation of another light emitting element the degree of degradation of which is comparatively high.

### SUMMARY OF THE INVENTION

With the display apparatus of Patent Document 1, ghosting can be corrected by carrying out a process of making the degree of degradation uniform among the light emitting elements within a period within which the display apparatus is not used. However, with the display apparatus, since degradation of a light emitting element the degree of degradation of which is low is promoted in conformity with another light emitting element the degree of degradation of which is high every time correction of ghosting is carried out, there is the possibility that degradation of all of the light emitting elements of the display apparatus may be promoted. Further, since correction of ghosting is carried out within a period within which the display apparatus is not used, the correction cannot be carried out during use of the display apparatus. Therefore, it seems a possible method to vary the gradation value of an image signal taking degradation of light emitting elements themselves into consideration to correct ghosting during use of the display apparatus.

For example, according to a possible correction method, the gradation value of an image signal is varied in response to the degree of degradation of a pixel circuit to display the image signal, and the varied image signal is used to cause the light emitting element to emit light. However, since the degree of degradation of the light emitting element differs among different pixel circuits and also the image signal to be supplied to the pixel circuit differs among different display targets, it is difficult to vary the gradation value, that is, to correct ghosting, with a high degree of accuracy for any image signal.

Therefore, it is desirable to provide a countermeasure which can correct ghosting of a display apparatus, which uses a light emitting element, with a high degree of accuracy.

The embodiments of the present invention provide a signal processing apparatus, a display apparatus and an electronic apparatus including, a conversion efficiency degradation value calculation section adapted to calculate a conversion efficiency degradation value regarding degradation of a conversion efficiency when driving current supplied to a light emitting element in each of a plurality of pixel circuits is converted into a luminance based on information regarding degradation of the conversion efficiency produced in response to lapse of light emission time of the light emitting element, a current amount degradation value calculation section adapted to calculate a current amount degradation value regarding degradation of the driving current based on information regarding degradation of the driving current produced in response to lapse of the light emission time of the light emitting element, and a correction section adapted to correct a gradation value of an image signal to be inputted to the pixel circuit based on the conversion efficiency degradation value and the current amount degradation value.

The embodiments of the present invention further provide a signal processing method including, and a program for causing a computer to execute, a conversion efficiency degradation value calculation step of calculating a conversion efficiency degradation value regarding degradation of a conversion efficiency when driving current supplied to a light emitting element in a pixel circuit is converted into a luminance based on information regarding degradation of the conversion efficiency produced in response to lapse of light emission time of the light emitting element, a current amount degradation value calculation step of calculating a current amount degradation value regarding degradation of the driving current based on information regarding degradation of the driving current produced in response to lapse of the light emission time of the light emitting element, and a correction step of correcting a gradation value of an image signal to be inputted to the pixel circuit based on the current amount degradation value and the conversion efficiency degradation value.

In the signal processing apparatus, display apparatus, electronic apparatus, signal processing method and program, the gradation value of an image signal to be inputted to each pixel circuit is corrected based on the conversion efficiency degradation value and the current amount degradation value.

The signal processing apparatus may be configured such that the current amount degradation value calculation section calculates the current amount degradation value of each of the pixel circuits based on the elapsed time of the light emission by the pixel circuit and a gradation value of the image signal in the elapsed time. In the signal processing apparatus, the current degradation value of the pixel circuit is calculated based on the elapsed time of the light emission by the pixel circuit and the gradation value of the image signal in the elapsed time.

Or, the signal processing apparatus may further include a current amount degradation information retaining section adapted to retain information which is information regarding degradation of the driving current supplied to the light emitting element and is successively added in response to lapse of the light emission time of the light emitting element as current amount degradation information in a unit of a pixel circuit, the current amount degradation value calculation section calculating the current amount degradation value in a unit of a pixel circuit based on a relationship between the current amount degradation information of that one of the pixel circuits which is a correction target and the current amount degradation information of the pixel circuit which is in an initial state and does not suffer from degradation of the driving current from within the current amount degradation information retained by the current amount degradation information retaining section. In the signal processing apparatus, the current amount degradation value is calculated in a unit of a pixel circuit based on the relationship between the current amount degradation information of the pixel circuit of the correction target and the current amount degradation information of the pixel circuit in the initial state.

Or else, the signal processing apparatus may further include a conversion efficiency degradation information retaining section adapted to retain information which is information regarding degradation of the conversion efficiency of the driving current supplied to the light emitting element and is successively added in response to lapse of the light emission time of the light emitting element as the conversion efficiency degradation information in a unit of a pixel circuit, the conversion efficiency degradation value calculation section calculating the conversion efficiency degradation value in a unit of a pixel circuit based on a relationship between the conversion efficiency degradation information of that one the pixel circuits which is a correction target and the conversion efficiency degradation information of the pixel circuit which is in an initial state and does not suffer from degradation of the conversion efficiency from within the conversion efficiency degradation information retained by the conversion efficiency degradation information retaining section. In the signal processing apparatus, the conversion efficiency degradation value is calculated in a unit of a pixel circuit based on the relationship between the conversion efficiency degradation information of the pixel circuit of the correction target and the conversion efficiency degradation information of the pixel circuit in the initial state.

As an alternative, the signal processing apparatus may further include a current amount degradation information retaining section adapted to retain information which is information regarding degradation of the driving current supplied to the light emitting element and is successively added in response to lapse of the light emission time of the light emitting element as the current amount degradation information in a unit of a pixel circuit, the current amount degradation value calculation section calculating the current amount degradation value in a unit of a pixel circuit based on a relationship between the current amount degradation information of that one of the pixel circuits which is a correction target and the current amount degradation information of another one of the pixel circuits which is used as a reference from within the current amount degradation information retained by the current amount degradation information retaining section. In the signal processing apparatus, the current amount degradation value is calculated in a unit of a pixel circuit using the current amount degradation information. In this instance, the pixel circuits may configure a display screen and the pixel circuit used as the reference is that one of the pixel circuits which exhibits greatest degradation of the driving current. In the signal processing apparatus, the current amount degradation value is calculated in a unit of a pixel circuit using the current amount degradation information of the pixel circuit which exhibits greatest degradation of the driving current as a reference.

As another alternative, the signal processing apparatus may further include a conversion efficiency degradation information retaining section adapted to retain information which is information regarding degradation of the conversion efficiency of the driving current supplied to the light emitting element and is successively added in response to lapse of the light emission time of the light emitting element as the conversion efficiency degradation information in a unit of a pixel circuit, the conversion efficiency degradation value calculation section calculating the conversion efficiency degradation value in a unit of a pixel circuit based on a relationship between the conversion efficiency degradation information of that one of the pixel circuits which is a correction target and the conversion efficiency degradation information of another one of the pixel circuits which is used as a reference from within the conversion efficiency degradation information retained by the conversion efficiency degradation information retaining section. In the signal processing apparatus, the conversion efficiency degradation value is calculated in a unit of a pixel circuit based on the conversion efficiency degradation information.

With the signal processing apparatus, display apparatus, electronic apparatus, signal processing method and program, a superior advantage that ghosting of a display apparatus which uses a light emitting element can be corrected with a high degree of accuracy during use of the display apparatus is achieved.

### BRIEF DESCRIPTION OF THE DRAWINGS

FIG. 1 is a block diagram showing an example of a configuration of a display apparatus according to a first embodiment of the present invention;

FIG. 2 is a circuit diagram schematically showing an example of a configuration of a pixel circuit in the display apparatus of FIG. 1;

FIG. 3 is a timing chart illustrating an example of basic operation of the pixel circuit of FIG. 2;

FIGS. 4A to 4C, 5A to 5C and 6 are schematic circuit diagrams illustrating different operation states of the pixel circuit of FIG. 2 within different periods;

FIGS. 7A and 7B are diagrams illustrating a relationship between a luminance inputted to a ghosting correction section shown in FIG. 1 and the luminance in the case where only correction of degradation of the conversion efficiency is carried out;

FIGS. 8A and 8B are schematic views illustrating an effect by correction of an image signal in the case where only correction of degradation of the conversion efficiency is carried out;

FIG. 9 is a block diagram showing an example of a functional configuration of the ghosting correction section shown in FIG. 1;

FIGS. 10 and 11 are block diagrams illustrating an example of production of a conversion efficiency degradation correction pattern and a current amount decrease correction pattern by a conversion efficiency degradation value calculation section and a current amount degradation value calculation section shown in FIG. 9, respectively;

FIGS. 12A and 12B are diagrams illustrating an example of production of a current amount decrease correction pattern by a current amount decrease information updating section shown in FIG. 9;

FIG. 13 is a diagram illustrating an example of a relationship between the current amount decrease information or light emission time period and the driving current decrease amount in the pixel circuit of FIG. 2;

FIGS. 14A to 14C are diagrams illustrating a relationship between the gradation inputted to the ghosting correction section shown in FIG. 1 and the luminance;

FIGS. 15A and 15B are schematic views illustrating an effect of correction of an image signal by the display apparatus of FIG. 1;

FIG. 16 is a flow chart illustrating an example of an updating processing procedure of conversion efficiency degradation information by a conversion efficiency degradation information integration section of the ghosting correction section of FIG. 9;

FIG. 17 is a flow chart illustrating an example of an updating processing procedure of current amount decrease information by a current amount decrease correction pattern production section of the ghosting correction section of FIG. 9;

FIG. 18 is a flow chart illustrating a production processing procedure of a conversion efficiency degradation correction pattern by a conversion efficiency degradation correction pattern production section of the ghosting correction section of FIG. 9;

FIG. 19 is a flow chart illustrating a production processing procedure of a current amount decrease correction pattern by a current amount decrease correction pattern production section of the ghosting correction section of FIG. 9;

FIG. 20 is a flow chart illustrating a correction processing procedure by a correction calculation section of the ghosting correction section of FIG. 9 in the case where a correction process is carried out for an image signal regarding one frame;

FIG. 21 is a perspective view showing a television set to which the present invention is applied;

FIG. 22 is perspective views showing a digital still camera to which the present invention is applied;

FIG. 23 is a perspective view showing a notebook type personal computer to which the present invention is applied;

FIG. 24 is front elevational views showing a portable terminal apparatus to which the present invention is applied in an unfolded state and a folded state; and

FIG. 25 is a perspective view showing a video camera to which the present invention is applied.

### DETAILED DESCRIPTION OF THE PREFERRED EMBODIMENTS

In the following, the present invention is described in detail in connection with preferred embodiments thereof. The description is given in the following order:

1. First Embodiment (display control: example of correction of ghosting with reference to a pixel circuit in an initial state)
2. Application of the Invention (display control: examples of an electronic apparatus)<

### 1. First Embodiment of the Invention

### Example of the Configuration of the Display Apparatus

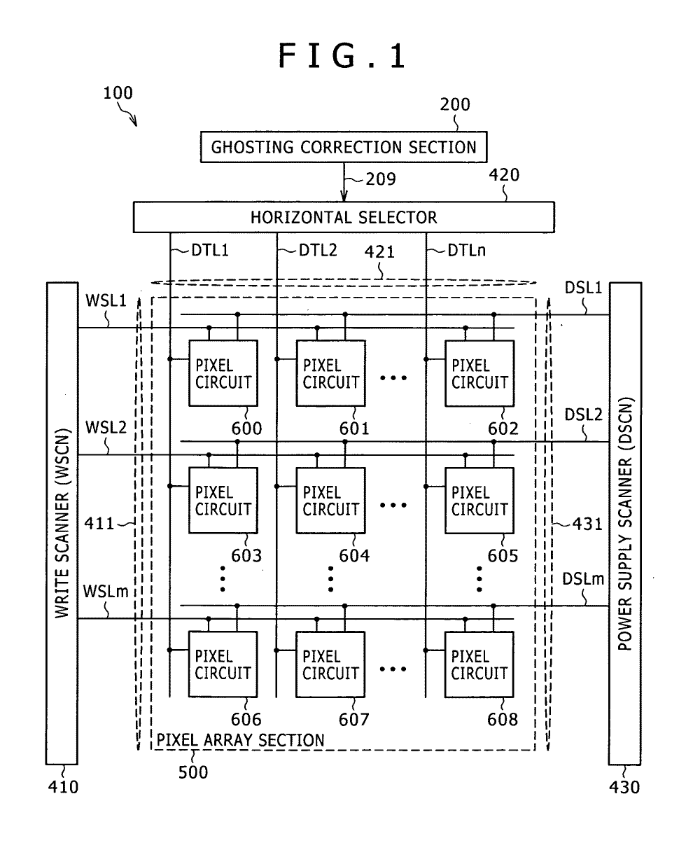

FIG. 1 shows an example of a configuration of a display apparatus 100 according to a first embodiment of the present invention. Referring to FIG. 1, the display apparatus 100 shown includes a ghosting correction section 200, a write scanner (WSCN: Write SCaNner) 410, and a horizontal selector (HSEL: Horizontal SELector) 420. The display apparatus 100 further includes a power supply scanner (DSCN: Drive SCaNner) 430 and a pixel array section 500. The pixel array section 500 includes n×m (m and n are integers equal to or greater than 2) pixel circuits 600 to 608 arrayed in a two-dimensional matrix. In FIG. 1, the nine pixel circuits 600 to 608 arrayed in the first, second and nth columns of the first, second and mth rows are shown for the convenience of illustration.

Meanwhile, the display apparatus 100 includes scanning lines (WSL: Write Scan Line) 411 for connecting the pixel circuits 600 to 608 and the write scanner (WSCN) 410 to each other. Further, the display apparatus 100 includes data lines (DTL: DaTa Line) 421 for connecting the pixel circuits 600 to 608 and the horizontal selector (HSEL) 420 to each other. In FIG. 1, the scanning lines (WSL1, WSL2 and WSLm) 411 of the first, second and mth rows and the data lines (DTL, DTL2 and DTLn) 421 of the first, second and nth columns are shown for the convenience of illustration.

Further, the display apparatus 100 includes power supply lines (DSL: Drive Scan Line) 431 for connecting the pixel circuits 600 to 608 and the power supply scanner (DSCN) 430 to each other. For the convenience of illustration, the power supply lines (DSL1, DSL2 and DSLm) 431 of the first, second and mth rows are shown in FIG. 1.

The ghosting correction section 200 varies the gradation value of an image signal in accordance with the degree of degradation of each of the pixel circuits 600 to 608 to correct ghosting. Here, the gradation value of an image signal is a value of the gradation of the image signal which designates a degree of the magnitude of the luminance of emitted light. Here, it is assumed that the magnitude of the luminance of emitted light is represented among 256 stages. Further, it is assumed that the luminance of emitted light based on an image signal having a gradation value “100” is degraded from 200 nit to 100 nit and the luminance of emitted light based on an image signal having a gradation value “200” is degraded from 300 nit to 100 nit by degradation of the pixel circuit 600. In this instance, the ghosting correction section 200 varies the gradation value of the image signal from “100” to “200” to correct ghosting.

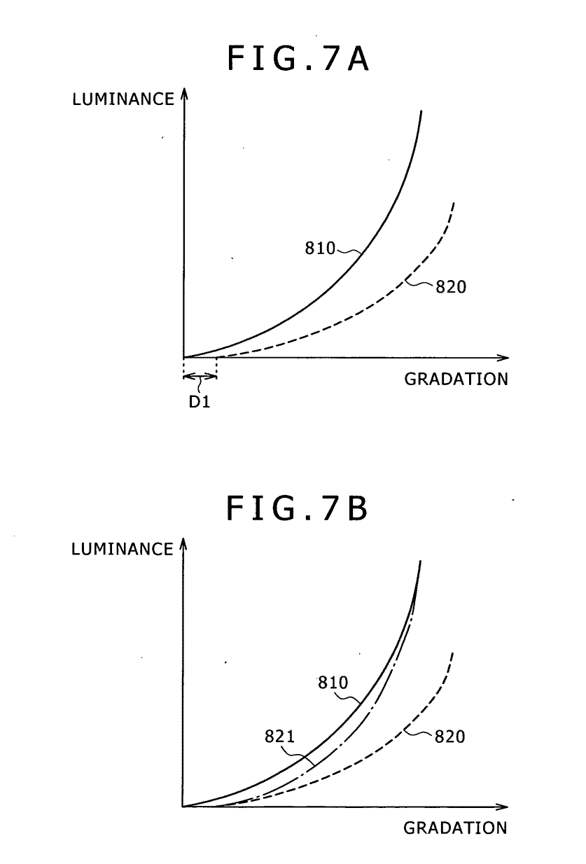

The ghosting correction section 200 supplies the corrected image signal to the horizontal selector 420 through a signal line 209. It is to be noted that a correction method by the ghosting correction section 200 of the display apparatus 100 according to the first embodiment of the present invention is hereinafter described in detail with reference to FIGS. 7A and 7B and so forth.

The write scanner (WSCN) 410 carries out line sequential scanning of sequentially scanning the pixel circuits 600 to 608 in a unit of a row. The write scanner (WSCN) 410 controls the timing at which data signals supplied from the data lines (DTL) 421 are to be written into the pixel circuits 600 to 608 in a unit of a row. The write scanner (WSCN) 410 generates an on potential for writing the data signal and an off potential for stopping the writing of the data signal as a scanning signal. The write scanner (WSCN) 410 supplies the generated scanning signal to the scanning lines 411.

The horizontal selector (HSEL) 420 supplies a data signal for setting the magnitude of the emitted light luminance of the pixel circuits 600 to 608 to the pixel circuits 600 to 608 in synchronism with the line sequential scanning by the write scanner (WSCN) 410. The horizontal selector (HSEL) 420 generates a potential of an image signal, that is, a signal potential, for setting the magnitude of the luminance of light to be emitted and a potential, that is, a reference potential, for carrying out correction of a threshold voltage, that is, threshold value correction, of a driving transistor which configures the pixel circuits 600 to 608 as a data signal. The horizontal selector (HSEL) 420 supplies the generated data signal to the data lines (DTL) 421.

The power supply scanner (DSCN) 430 generates a power supply signal for driving the pixel circuits 600 to 608 in a unit of a row in synchronism with the line sequential scanning by the write scanner (WSCN) 410. The power supply scanner (DSCN) 430 generates a power supply potential for driving the pixel circuits 600 to 608 and an initialization potential for initializing the pixel circuits 600 to 608 as a power supply signal. The power supply scanner (DSCN) 430 supplies the generated power supply signal to the power supply lines (DSL) 431.

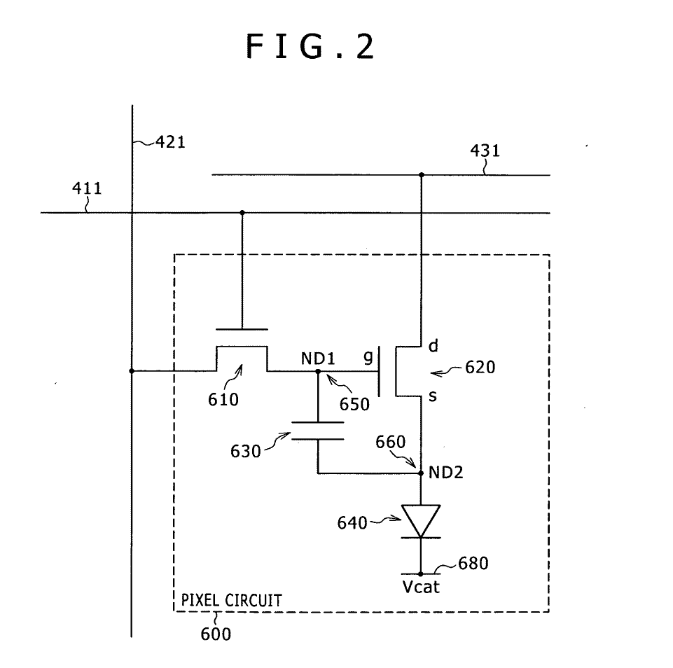

The pixel circuits 600 to 608 retain the potentials of the image signal from the data lines (DTL) 421 based on the scanning signals from the scanning lines 411 and emit light for a predetermined period of time in accordance with the retained potentials. Here, an example of the configuration of the pixel circuits 600 to 608 is described with reference to FIG. 2.

### Example of the Configuration of the Pixel Circuit

FIG. 2 schematically shows an example of a configuration of the pixel circuits 600 to 608 according to the first embodiment of the present invention. It is to be noted that, since the pixel circuits 600 to 608 have the same configuration, description is given principally of the pixel circuit 600 with reference to FIG. 2 and so forth while description of the other pixel circuits 601 to 608 is partly omitted herein to avoid redundancy.

Referring to FIG. 2, the pixel circuit 600 includes a write transistor 610, a driving transistor 620, a holding capacitor 630 and a light emitting element 640. It is assumed here that the write transistor 610 and the driving transistor 620 are each formed from an n-channel transistor.

In the pixel circuit 600, a scanning line (WSL) 411 and a data line (DTL) 421 are connected to the gate terminal and the drain terminal of the write transistor 610, respectively. Meanwhile, the gate terminal g of the driving transistor 620 and one of electrodes of the holding capacitor 630 are connected to the source terminal of the write transistor 610. Here, the connecting point of them is defined as first node (ND1) 650. Meanwhile, a power supply line (DSL) 431 is connected to the drain terminal d of the driving transistor 620, and the other electrode or terminal of the holding capacitor 630 and the anode electrode of the light emitting element 640 are connected to the source terminal s of the driving transistor 620. Here, the connecting point of them is defined as second node (ND2) 660.

The write transistor 610 supplies a data signal from the power supply line (DSL) 431 to the first node (ND1) 650 in accordance with a scanning signal from the scanning line (WSL) 411. In order to eliminate a dispersion of the threshold voltage of the driving transistor 620 of the pixel circuit 600, the write transistor 610 supplies a reference potential for the data signal to the one electrode of the holding capacitor 630. The reference potential here signifies a fixed potential which is used as a reference for holding a potential corresponding to the threshold voltage of the driving transistor 620 in the holding capacitor 630.

Further, the write transistor 610 writes the signal potential of the data signal to the one electrode of the holding capacitor 630 after a voltage corresponding to the threshold voltage of the driving transistor 620 is held into the holding capacitor 630.

The driving transistor 620 outputs driving current to the light emitting element 640 based on the signal voltage held in the holding capacitor 630 in response to the signal potential in order to drive the light emitting element 640 to emit light. The driving transistor 620 outputs driving current corresponding to the signal voltage held in the holding capacitor 630 to the light emitting element 640 in a state in which the power supply potential for driving the driving transistor 620 is applied to the driving transistor 620 from the power supply line (DSL) 431.

The holding capacitor 630 is used to hold a voltage corresponding to the data signal supplied thereto from the write transistor 610. In particular, the holding capacitor 630 plays a role of holding a signal voltage corresponding to the signal potential written therein by the write transistor 610.

The light emitting element 640 emits light in accordance with the magnitude of driving current outputted from the driving transistor 620. Further, the light emitting element 640 is connected at an output terminal thereof to a cathode line 680. From the cathode line 680, a cathode potential Vcat is supplied as a reference potential for the light emitting element 640. The light emitting element 640 can be implemented, for example, by an organic EL element.

It is to be noted that, while it is assumed that, in the example shown in FIG. 2, the write transistor 610 and the driving transistor 620 are each formed from an re-channel transistor, they are not limited to the transistors of the configuration described. For example, the write transistor 610 and the driving transistor 620 may each be formed from a p-channel transistor. Further, they may be of the enhancement type, of the depletion type or of the dual gate type.

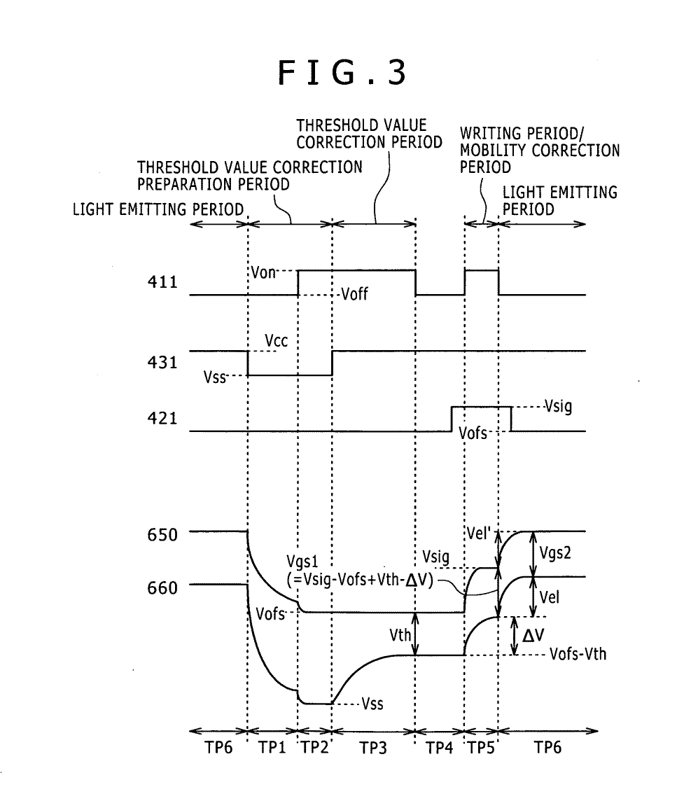

Further, while the pixel circuit 600 is configured such that it includes the two transistors 610 and 620 and the single holding capacitor 630 to supply driving current to the light emitting element 640, the configuration of the pixel circuit 600 is not limited to this. In particular, only it is necessary for the pixel circuit 600 to include the driving transistor 620 and the light emitting element 640. For example, even if the pixel circuit 600 includes three or more transistors to control light emission, only it is necessary for the pixel circuit 600 to include the driving transistor 620 and the light emitting element 640. Now, an example of operation of the pixel circuit 600 described above is described in detail with reference to FIG. 3.

### Example of Basic Operation of the Pixel

FIG. 3 is a timing chart illustrating an example of basic operation of the pixel circuit 600 having the configuration described hereinabove with reference to FIG. 2. Here, the axis of abscissa is a common time axis, and potential variations of the scanning line (WSL) 411, power supply line (DSL) 431, data line (DTL) 421, first node (ND1) 650 and second node (ND2) 660 are illustrated. It is to be noted that the length of the axis of abscissa indicative of time periods is indicated schematically but does not indicate ratios in time length among the time periods.

In the timing chart of FIG. 3, transition of operation of the pixel circuit 600 is delineated into six periods from TP1 to TP6 for the convenience of illustration. First, within the light emitting period TP6, the light emitting element 640 is in a light emitting state. Within this light emitting period TP6, the potential of the scanning signal of the scanning line (WSL) 411 is set to an off potential Voff. Further, within this light emitting period TP6, the potential of the power supply signal of the power supply line (DSL) 431 is set to a power supply potential Vcc.

Thereafter, a new field in line sequential scanning is entered, and within the threshold value correction preparation period TP1, the potential of the power supply line (DSL) 431 is set to an initialization potential Vss for initializing the second node (ND2) 660. Consequently, the potentials at the first node (ND1) 650 and the second node (ND2) 660 drop.

Then within the threshold value correction preparation period TP2, the potential of the scanning line (WSL) 411 is set to an on potential Von to initialize the potential at the first node (ND1) 650 to a reference potential Vofs. Consequently, the potential at the second node (ND2) 660 is initialized to the initialization potential Vss. Preparations for a threshold value correction operation are completed by such initialization of the first node (ND1) 650 and the second node (ND2) 660.

Thereafter, within the threshold value correction period TP3, a threshold value correction operation for carrying out correction for the threshold voltage of the driving transistor 620 of the pixel circuit 600 is carried out. At this time, the power supply signal of the power supply line (DSL) 431 is set to the power supply potential Vcc so that a voltage Vth corresponding to the threshold voltage of the driving transistor 620 is retained between the first node (ND1) 650 and the second node (ND2) 660. In other words, the voltage Vth corresponding to the threshold voltage is held in the holding capacitor 630.

Thereafter, within the period TP4, the potential of the scanning signal supplied to the scanning line (WSL) 411 is varied to the off potential Voff, and then the data signal of the data line (DTL) 421 is changed over from the reference potential Vofs to a signal potential Vsig.

Then, within the writing period/mobility correction period TP5, a writing operation of an image signal and a mobility correction operation for carrying out correction of the mobility of the driving transistor 620 are carried out. At this time, the potential of the scanning signal of the scanning line (WSL) 411 is changed over to the on potential Von, and consequently, the potential at the first node (ND1) 650 rises to the signal potential Vsig. In other words, the signal potential Vsig is written into the first node (ND1) 650 by the write transistor 610.

In contrast, the potential at the second node (ND2) 660 rises by a rise amount ΔV according to the mobility of the driving transistor 620 corresponding to the signal potential Vsig with respect to the threshold potential Vofs−Vth provided within the threshold value correction period TP3. In other words, the potential at the second node (ND2) 660 rises by ΔV as a result of the mobility correction operation.

In this manner, within the writing period/mobility correction period TP5, the signal potential Vsig is applied to the one electrode of the holding capacitor 630 while the potential which is the sum of the threshold voltage Vofs−Vth and the rise amount ΔV is applied to the other electrode of the holding capacitor 630. In other words, “Vsig−(Vofs−Vth)+ΔV” is held as a signal voltage Vgs1 corresponding to the image signal in the holding capacitor 630. The signal voltage Vsig−(Vofs−Vth)+ΔV held in the holding capacitor 630 in this manner is corrected with the voltage Vth corresponding to the threshold voltage of the driving transistor 620 and the rise amount ΔV by the mobility correction operation. Therefore, a signal voltage free from an influence of the dispersion in threshold voltage and mobility of the driving transistor 620 among the pixel circuits 600 to 608 is obtained.

Thereafter, within the light emitting period TP6, the potential of the scanning signal of the scanning line (WSL) 411 is set to the off potential Voff to place the first node (ND1) 650 into a floating state. Then, the potential at the second node (ND2) 660 rises by “Vel” with respect to the potential Vofs−Vth+ΔV given within the writing period/mobility correction period TP5. The potential rise amount Vel at the second node (ND2) 660 increases as the signal potential Vsig of the image signal increases. At this time, since the potential at the second node (ND2) 660 becomes higher than the light emission potential Vthel+Vcat which is decided by the threshold voltage Vthel of the light emitting element 640 and the cathode potential Vcat of the cathode line 680, the light emitting element 640 emits light.

Meanwhile, also the potential at the first node (ND1) 650 rises by “Vel′” from the signal potential Vsig in such a manner as to follow up the potential rise at the second node (ND2) 660 through the coupling therebetween by the holding capacitor 630. The action that, upon a potential rise at the second node (ND2) 660, the potential at the first node (ND1) 650 which is in a floating state rises through the coupling arising from the holding capacitor 630 in this manner is called bootstrap action.

In this bootstrap action, the potential rise amount Vel′ at the first node (ND1) 650 is suppressed in comparison with the potential rise amount Vel at the second node (ND2) 660. The relationship between the potential rise amount Vel at the second node (ND2) 660 and the potential rise amount Vel′ at the first node (ND1) 650 can be represented by the following expression 1:

Vel′=Gb×Vel expression 1

where Gb is a value lower than “1.0” and can be represented by the following expression 2. It is to be noted here that Gb is referred to as bootstrap gain.

Gb=Cs/(Cs+Cp) expression 2

where Cs is the capacitance value of the holding capacitor 630, and Cp is the sum of the capacitance values of a parasitic capacitor between the gate and the source of the write transistor 610, that is, the write transistor gs parasitic capacitor, and a parasitic capacitor between the gate and the drain of the driving transistor 620, that is, the driving transistor gd parasitic capacitor. It is to be noted here that the parasitic capacitor which drops the bootstrap gain Gb is given taking only the write transistor gs parasitic capacitor and the driving transistor gd parasitic capacitor into consideration.

From the expression 2, it can be recognized that the bootstrap gain Gb assumes a value lower than “1.0” due to the capacitance value Cp of the write transistor gs parasitic capacitor and the driving transistor gd parasitic capacitor. This bootstrap gain Gb varies in response to the magnitude of the capacitance value Cp of the write transistor gs parasitic capacitor and the driving transistor gd parasitic capacitor. In particular, as the capacitance value Cp of the write transistor gs parasitic capacitor and the driving transistor gd parasitic capacitor increases, the bootstrap gain Gb decreases. Further, since the magnitude of the capacitance value Cp differs among the different pixel circuits 600 to 608, also the magnitude of the bootstrap gain Gb differs among the different pixel circuits 600 to 608.

Since the bootstrap gain Gb has a value lower than “1.0” due to the capacitance value Cp of the write transistor gs parasitic capacitor and the driving transistor gd parasitic capacitor in this manner, the potential rise amount Vel′ at the first node (ND1) 650 is smaller than the potential rise amount Vel at the second node (ND2) 660. Therefore, the signal voltage Vgs2 within the light emitting period TP6 is lower by “Vel−Vel′=Vel·(1−Gb)” than the signal voltage Vgs1 within the writing period/mobility correction period TP5. It is to be noted that, intermediately of the light emitting period TP6, the data signal of the data line (DTL) 410 is changed over from the signal voltage Vsig to the reference potential Vofs. Accordingly, within the light emitting period TP6, the light emitting element 640 emits light of a luminance corresponding to the signal voltage of Vsig−Vofs+Vth−ΔV−(Vel−Vel′).

### Details of the Operating State of the Pixel

Now, an example of transition of the operation of the pixel circuit 600 described hereinabove is described in detail with reference to the accompanying drawings.

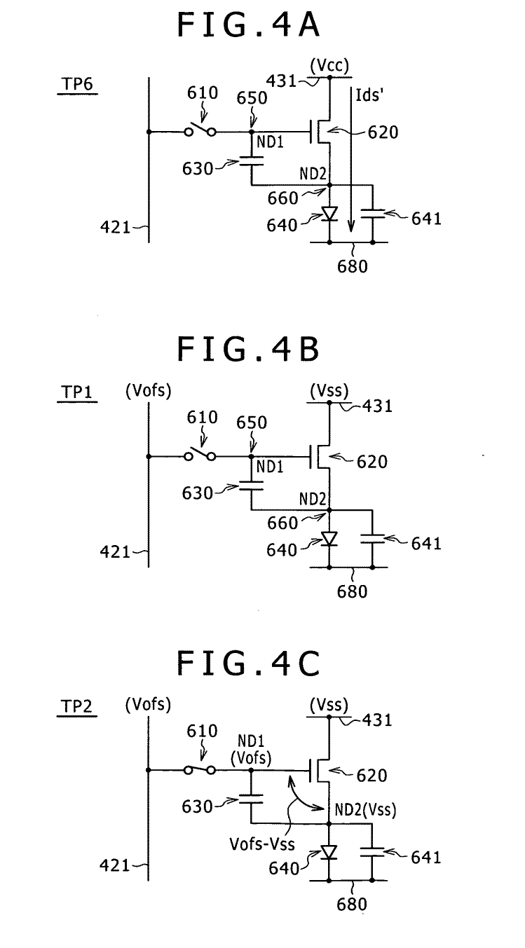

FIGS. 4A to 6 schematically illustrate an example of transition of operation of the pixel circuit 600 according to the first embodiment of the present invention. Particularly, FIGS. 4A to 6 illustrate operation states of the pixel circuit 600 corresponding to the period TP1 to TP6 of the timing chart shown in FIG. 3. Further, for the convenience of illustration, the parasitic capacitor 641 of the light emitting element 640 is shown. Furthermore, the write transistor 610 is shown as a switch while the scanning line (WSL) 411 is omitted.

FIGS. 4A to 4C schematically illustrate operation states of the pixel circuit 600 corresponding to the period TP6, TP1 and TP2, respectively. First, within the light emitting period TP6, the write transistor 610 is in an off or non-conducting state and the power supply potential Vcc is applied from the power supply line (DSL) 431 to the driving transistor 620 as seen in FIG. 4A. Further, since driving current Ids′ is supplied from the driving transistor 620 to the light emitting element 640, the light emitting element 640 emits light of a luminance corresponding to the driving current Ids′.

Then, within the threshold value correction preparation period TP1, the power supply signal of the power supply line (DSL) 431 changes from the power supply potential Vcc to the initialization potential Vss as seen in FIG. 4B. Consequently, since the potential at the second node (ND2) 660 drops, the light emitting element 640 is placed into a no-light emitting state. At this time, since the first node (ND1) 650 is in a floating state, also the potential at the first node (ND1) 650 drops in such a manner as to follow up the potential drop at the second node (ND2) 660.

Then, within the threshold value correction preparation period TP2, the potential of the scanning line (WSL) 411 (shown in FIG. 2) changes to the on potential Von as seen in FIG. 4C, the write transistor 610 is placed into an on or conducting state. Consequently, the potential at the first node (ND1) 650 is initialized to the reference potential Vofs from the data line (DTL) 421.

On the other hand, the potential at the second node (ND2) 660 is initialized to the initialization potential Vss of the power supply line (DSL) 431. Consequently, the potential difference between the first node (ND1) 650 and the second node (ND2) 660 becomes “Vofs−Vss.” It is to be noted here that the initialization potential Vss of the power supply line (DSL) 431 is assumed to be set to a potential sufficiently lower than the reference potential Vofs.

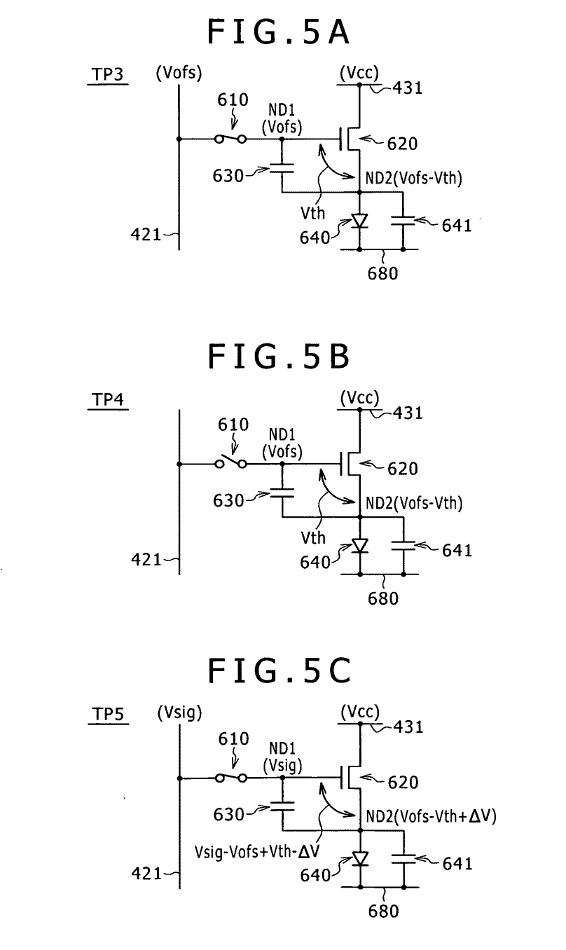

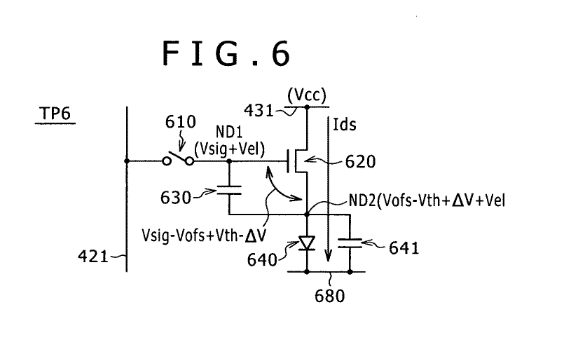

FIGS. 5A to 5C schematically illustrate operation states of the pixel circuit 600 corresponding to the periods TP3 to TP5, respectively.

Within the threshold value correction period TP3 next to the threshold value correction preparation period TP2, the power supply signal of the power supply line (DSL) 431 changes to the power supply potential Vcc. Consequently, the driving transistor 620 is placed into an on state to allow current to be supplied from the driving transistor 620 to the second node (ND2) 660 to raise the potential at the second node (ND2) 660. In this instance, the potential at the second node (ND2) 660 rises until the potential difference between the first node (ND1) 650 and the second node (ND2) 660 becomes equal to the potential difference Vth corresponding to the threshold voltage of the driving transistor 620.

The voltage Vth corresponding to the threshold voltage of the driving transistor 620 is held into the holding capacitor 630 in this manner. This is a threshold value correction operation. It is to be noted that the cathode potential Vcat of the cathode line 680 and the reference potential Vofs from the data line (DTL) 421 are set in advance so that current from the driving transistor 620 may not flow to the light emitting element 640.

Thereafter, within the period TP4, the scanning signal supplied from the scanning line (WSL) 411 changes to the off potential Voff to place the write transistor 610 into an off state as seen in FIG. 5B. Then, the potential of the data signal of the data line (DTL) 421 changes from the reference potential Vofs to the signal potential Vsig of the image signal. Here, the write transistor 610 is kept in an off state within a period before the data signal reaches the signal potential Vsig of the image signal taking the transient characteristic of the data line (DTL) 421 into consideration.

Then, within the writing period/mobility correction period TP5, the potential of the scanning signal of the scanning line (WSL) 411 changes to the on potential Von as seen in FIG. 5C to place the write transistor 610 into an on state. Consequently, since the signal potential Vsig of the image signal is written into the one electrode of the holding capacitor 630 by the write transistor 610, the potential at the first node (ND1) 650 is set to the signal potential Vsig of the image signal.

At this time, since current corresponding to the mobility of the driving transistor 620 flows from the driving transistor 620 into the second node (ND2) 660, the holding capacitor 630 and the parasitic capacitor 641 are charged to raise the potential of the second node (ND2) 660. Then, the potential at the second node (ND2) 660 rises by the rise amount ΔV corresponding to the mobility of the driving transistor 620 from the threshold potential Vofs−Vth. This is a mobility correction operation.

Consequently, the signal voltage Vgs1 which is a potential difference between the first node (ND1) 650 and the second node (ND2) 660 becomes “Vsig−Vofs+Vth−ΔV.” In other words, the holding capacitor 630 holds “Vsig−Vofs+Vth−ΔV” as the signal voltage Vgs1 therein.

Within the writing period/mobility correction period TP5, writing of the signal potential Vsig of the image signal and adjustment of the rise amount ΔV by mobility correction are carried out in this manner. At this time, since the current from the driving transistor 620 increases as the signal potential Vsig of the image signal increases, also the rise amount ΔV by mobility correction increases. Accordingly, mobility correction in accordance with the luminance level, that is, with the potential of the image signal, can be carried out.

On the other hand, in the case where the potentials Vsig of the image signals to the pixel circuits 600 to 608 are fixed, as the mobility of the driving transistor 620 increases, also the rise amount ΔV by mobility correction increases among, the pixel circuits 600 to 608. In particular, in that one of the pixel circuits 600 to 608 in which the mobility of the driving transistor 620 is high, current from the driving transistor 620 is higher than another one of the pixel circuits 600 to 608 in which the mobility of the driving transistor 620 is low, and the gate-source voltage of the driving transistor 620 decreases as much. Accordingly, in the pixel circuit 600 in which the mobility of the driving transistor 620 is high, driving current outputted from the driving transistor 620 is adjusted to a level similar to those of the pixel circuits 600 to 608 in which the mobility of the driving transistor 620 is low. A dispersion in mobility of the driving transistor 620 among the pixel circuits 600 to 608 is removed in this manner.

FIG. 6 schematically illustrates an operation state of the pixel circuit 600 within the light emitting period TP6.

Within the light emitting period TP6, the potential of the scanning signal supplied from the scanning line (WSL) 411 changes to the off potential Voff as seen in FIG. 6 to place the write transistor 610 into an off state. The potential at the second node (ND2) 660 rises by the potential rise amount Vel corresponding to the magnitude of the driving current from the driving transistor 620 from the potential Vofs−Vth+ΔV applied within the writing period/mobility correction period TP5.

On the other hand, the potential at the first node (ND1) 650 rises at a ratio represented by the expression 1 given hereinabove by a bootstrap operation arising from the holding capacitor 630. The potential rise amount Vel′ at the first node (ND1) 650 at this time is a value obtained by multiplying the potential rise amount Vel at the second node (ND2) 660 by the bootstrap gain Gb which is lower than “1.0.” In particular, since the potential rise amount Vel′ at the first node (ND1) 650 is suppressed in response to the capacitance value Cp of the write transistor gs parasitic capacitor and the driving transistor gd parasitic capacitor, the potential rise amount Vel′ is smaller than the potential rise amount Vel at the second node (ND2) 660.

Consequently, the signal voltage Vgs2 which is a potential difference between the first node (ND1) 650 and the second node (ND2) 660 is lower by “Vel−Vel′” in comparison with the signal voltage Vgs1 at time immediately prior to the end of the writing period/mobility correction period TP5. In other words, the signal voltage Vgs2 at time immediately prior to the end of the light emitting period TP6 becomes “Vgs1−(Vel−Vel′)” which is lower than the signal voltage Vgs1 within the writing period/mobility correction period TP5. Accordingly, the light emitting element 640 emits light of a luminance in accordance with the driving current Ids1 corresponding to the signal voltage Vgs2 within the light emitting period TP6.

As described above with reference to FIGS. 3A to 6, the pixel circuit 600 of the display apparatus 100 according to the first embodiment of the present invention emits light of a luminance in accordance with driving current when the driving current in accordance with the signal potential supplied through the data line (DTL) 421 is supplied to the light emitting element 640. Therefore, if the driving transistor 620, light emitting element 640 or some other component of the pixel circuit 600 degrades, then the value of the luminance with respect to the signal potential is displaced from that in the initial state by the variation of the mount of driving current or of the amount of emitted light. If this displacement occurs by an equal amount with all pixel circuits, then a phenomenon that an image which has been displayed immediately before then looks remaining, that is, a ghosting phenomenon, does not appear.

However, since an organic EL element represents a gradation by varying the amount of light to be emitted therefrom in response to image data to be displayed, the degree of degradation of the organic EL element differs among the different pixel circuits of the display screen. Therefore, display of a pixel circuit which suffers much from degradation becomes darker than display of surrounding pixel circuits, resulting in appearance of a ghosting phenomenon.

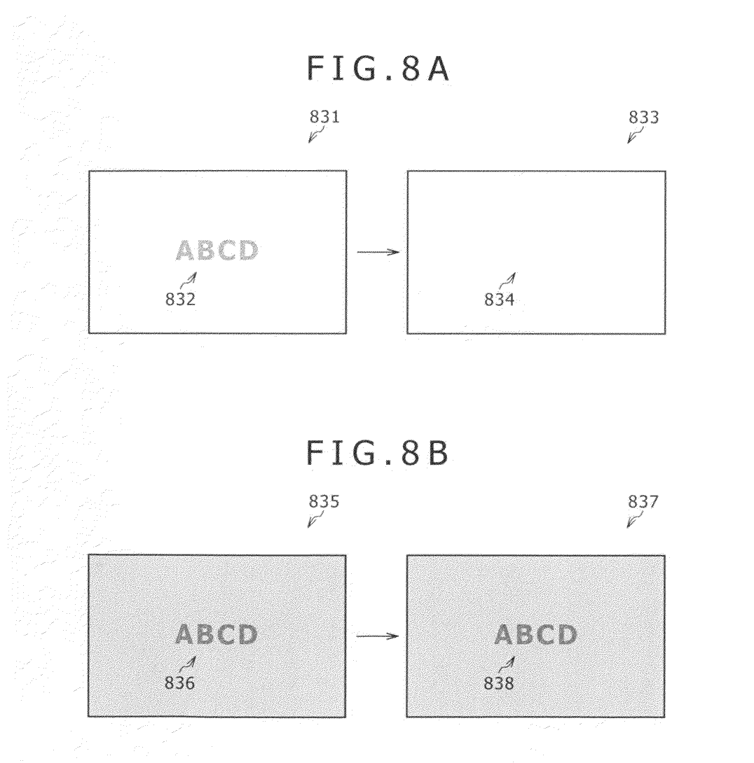

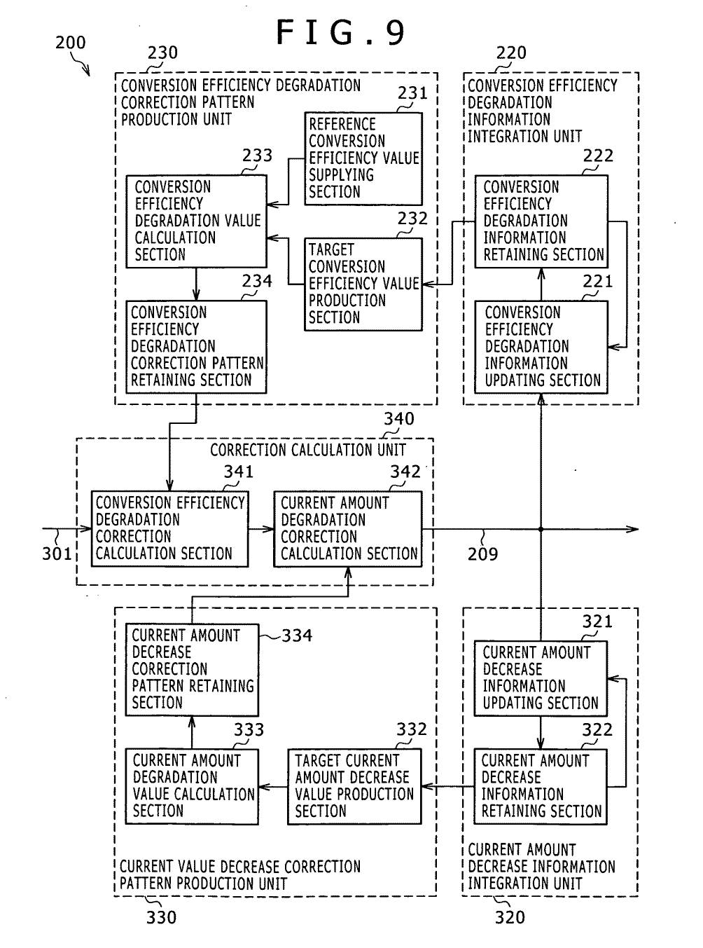

Now, an example of correction of ghosting by the ghosting correction section 200 of the display apparatus 100 in the case where only correction of degradation of the conversion efficiency is carried out in the first embodiment of the present invention is described with reference to FIGS. 7A to 8B.

### Example of a Pixel Characteristic Curve of a Corrected Image Signal

FIGS. 7A and 7B illustrate a relationship between the gradation inputted to the ghosting correction section 200 and the luminance in the case where only correction of gradation of the conversion efficiency is carried out. The graphs shown in FIGS. 7A and 7B indicate pixel characteristic curves in which the axis of abscissa indicates the value of the gradation of the image signal inputted to the ghosting correction section 200, that is, of the input gradation value and the axis of ordinate indicates the value of the luminance of emitted light from the pixel circuits 600 to 608, that is, of the luminance value. Further, it is assumed that the potential representing each gradation with an input gradation value is equal to the voltage Vsig−Vofs which represents each gradation of the data signal supplied to the pixel circuits 600 to 608.

Further, in the present example, it is assumed that only information regarding degradation of the conversion efficiency of the light emitting element 640 is used to carry out correction. Further, in the present example, it is assumed that the image signal is corrected taking a pixel characteristic of a pixel circuit in an initial state in which the pixel circuit suffers from no degradation as yet as a reference to correction. In particular, in the present example, it is assumed that the ghosting correction section 200 corrects the image signal so that, taking a pixel characteristic of a pixel circuit in an initial state in which the pixel circuit suffers no degradation as yet as a reference to correction, the pixel characteristic of any of the pixel circuits 600 to 608 which suffers from degradation together with use of the display apparatus 100 may coincide with the reference. Further, it is assumed that the ghosting correction section 200 corrects ghosting in a high gradation from among the gradations represented by the pixel circuits 600 to 608 with a high degree of accuracy.

FIG. 7A illustrates a pixel characteristic of a pixel circuit in an initial state and a degraded pixel characteristic of a pixel circuit.

The pixel characteristic (initial) 810 in the initial state is a curve indicative of a relationship between an input gradation value of a pixel circuit in the initial state and the luminance value.

Here, the pixel characteristic (initial) 810 is described. This pixel characteristic (initial) 810 is represented by a quadratic function given by the following expression 3:

L=A×S² expression 3

where L is the luminance value, and A is a coefficient which is decided in accordance with the conversion efficiency of the light emitting element 640, that is, an efficiency coefficient while S is a gradation value of the data signal supplied to the pixel circuit in the initial state and is the voltage Vsig−Vofs.

In the expression 3, the source terminal S has a value corresponding to the gate-source voltage of the driving transistor 620. Further, S² has a value calculated using the square characteristic of the driving transistor 620 and corresponding to driving current supplied to the light emitting element 640. The luminance value L can be calculated by multiplying the driving current S² by the conversion efficiency A of the light emitting element 640 in this manner.

The pixel characteristic (correction target) 820 is a curve representative of a relationship between the input gradation value and the luminance value of a pixel circuit whose light emitting element is degraded together with lapse of time. In particular, this pixel characteristic (correction target) 820 is a curve illustrating a relationship between the input gradation value and the luminance value of a pixel circuit in the case where correction of the input gradation value is not carried out, for example, of one of the pixel circuits 600 to 608.

With the present pixel characteristic (correction target) 820, since degradation of the efficiency in conversion of driving current into luminance by the light emitting element 640, that is, conversion efficiency degradation, occurs, the gradient of the curve is moderate in comparison with the pixel characteristic (initial) 810. Further, in the case where the pixel characteristic (correction target) 820 is compared with the pixel characteristic (initial) 810, it is shifted to the right side by an amount corresponding to the driving current amount decrease component D1 in the direction of the axis of abscissa.

Here, the driving current amount decrease component D1 is described. The driving current amount decrease component D1 is a component indicative of the decrease amount of the driving current, that is, the driving current decrease amount. This driving current amount decrease component D1 originates from degradation of the driving transistor 620 and the light emitting element 640. In particular, if the driving transistor 620 is degraded, then the driving current to be supplied decreases in response to the signal voltage Vgs2. On the other hand, if the light emitting element 640 is degraded, then the threshold voltage Vthel of the light emitting element 640 increases, and this increases the potential rise amount Vel at the second node (ND2) 660 within the light emitting period TP6 illustrated in FIG. 3. Further, since the signal voltage Vgs2 within the light emitting period TP6 decreases by “Vel−Vel′=Vel·(1−Gb)” from the signal voltage Vgs1, the signal voltage Vgs2 decreases in response to increase of the threshold voltage Vthel of the light emitting element 640. In other words, if the light emitting element 640 is degraded, then since the signal voltage Vgs2 decreases, the current amount of the driving current decreases. In this manner, the driving current amount decrease component D1 arises from decrease of the current amount of the driving current to be supplied in response to the signal voltage Vgs2 and decrease of the signal voltage Vgs2.

Now, the pixel characteristic (correction target) 820 is described. This pixel characteristic (correction target) 820 is represented by a quadrature function given by the following expression 4:

L_{d}=A_{d}×(S−ΔS)² expression 4

where L_{d} is the luminance value of the pixel circuit of the correction target and A_{d} is a coefficient which is decided in response to the conversion efficiency of the light emitting element 640 of the pixel circuit of the correction target while ΔS is the driving current decrease amount indicated as the driving current amount decrease component D1.

In the expression 4 above, (S−ΔS)² indicates the driving current supplied to the light emitting element with regard to which the driving current amount decrease component D1 is taken into consideration. The degraded luminance value L_{d} can be calculated by multiplying the driving current (S−ΔS)² with the driving current amount decrease component D1 taken into consideration in this manner by the degraded conversion efficiency A_{d} of the light emitting element 640.

In this manner, if a pixel circuit is degraded together with use of the display apparatus 100, then since degradation of the conversion efficiency and decrease of the driving current occur, the luminance value with respect to a gradation value of the image signal drops. It is to be noted that the conversion efficiency degradation corresponds to the degradation of the gradient of the pixel characteristic and the decrease of the driving current corresponds to a gradation shift. Therefore, the influence of the conversion efficiency degradation is significant with a gradation with which a high luminance is represented by the pixel circuit, that is, with a high gradation. On the other hand, with a gradation with which a low luminance is represented by the pixel circuit, that is, with a low gradation, the influence of the decrease of the driving current is significant.

FIG. 7B illustrates a pixel characteristic where the image signal to be supplied to a pixel circuit which has the pixel characteristic indicated by the pixel characteristic (correction target) 820 is corrected as a correction pixel characteristic (correction target) 821.

The correction pixel characteristic (correction target) 821 is a pixel characteristic in the case where the image signal to be supplied to a pixel circuit of the characteristic indicated by the pixel characteristic (correction target) 820 is corrected with reference to the characteristic indicated by the pixel characteristic (initial) 810. This correction pixel characteristic (correction target) 821 is proximate to the pixel characteristic (correction target) 820 in low gradations, whereas it is proximate to the pixel characteristic (initial) 810 in high gradations. In other words, this correction pixel characteristic (correction target) 821 indicates that, if only correction of degradation of the conversion efficiency is carried out, then although the input gradation value in high gradations is corrected with a higher degree of accuracy, the input gradation value in low gradations is corrected little.

Here, a correction method of the ghosting correction section 200 of the display apparatus 100 in the case where only correction of degradation of the conversion efficiency is carried out is described. The ghosting correction section 200 varies the gradation of the image signal based on the following expression 5:

Sₒᵤₜ=(ΔA)^{-1/2}×Sᵢₙ expression 5

ΔA=A_{d}/A expression 6

where Sₒᵤₜ is the gradation value of the image signal corrected by the ghosting correction section 200 and Sᵢₙ is the gradation value of the image signal before corrected by the ghosting correction section 200 while ΔA is a value of a fraction indicative of the ratio in conversion efficiency in which the conversion efficiency A_{d} of the correction target pixel circuit is the numerator and the conversion efficiency A of the pixel circuit in the initial state is the denominator, that is, the conversion efficiency degradation value.

In order to change the gradation value of the image signal based on the expression 5 given above, the ghosting correction section 200 retains information regarding degradation of the individual pixel circuits 600 to 608 and calculates efficiency coefficients of the pixel circuits 600 to 608 from the degradation information. Then, the ghosting correction section 200 calculates the value ΔA and changes the gradation of the image signal based on the calculated value ΔA to produce a value of the corrected gradation of the image signal, that is, a correction gradation value. Consequently, the pixel characteristic by the corrected image signal becomes the pixel characteristic indicated by the correction pixel characteristic (correction target) 821.

In the expression 5 given hereinabove, the influence of the driving current decreasing amount ΔS illustrated in FIG. 4 is not taken into consideration. Therefore, in the case where only the conversion efficiency degradation value ΔA is used to carry out correction, correction in low gradations or high gradations is inaccurate.

Further, by measuring the degradation of the luminance of a pixel circuit using an image signal of a particular gradation value, a conversion efficiency degradation value ΔA for a correction target pixel circuit including both of the influences of the driving current decreasing amount ΔS and the conversion efficiency degradation value ΔA can be calculated. However, since the driving current decreasing amount ΔS is a shift of the gradation of the pixel characteristic and the conversion efficiency degradation value ΔA is a variation of the gradient of the pixel characteristic, the conversion efficiency degradation value ΔA which includes the influences of both of them gives rise to an error similar to that of FIG. 7B in correction of the other gradation values than the measured gradation value.

In this manner, in the case where only correction of degradation of the conversion efficiency is carried out, the difference in luminance in low gradations or high gradations can be corrected, but there is the possibility that the difference in luminance in the other of low gradations and high gradations may not be able to be corrected. Therefore, in the first embodiment of the present invention, correction is carried out taking the influence of the conversion efficiency degradation value ΔA and the driving current decreasing amount ΔS into consideration.

Example of Display after Correction

FIGS. 8A and 8B illustrate an effect of correction of an image signal in the case where only correction of degradation of the conversion efficiency is carried out. Particularly, FIGS. 8A and 8B illustrate an effect of correction in the case where ghosting is corrected by the method described hereinabove with reference to FIGS. 7A and 7B. Further, it is assumed here that ghosting of characters “ABCD” appears on the display screen of the display apparatus 100.

FIG. 8A shows a comparative example of the display screen in the case where an image signal of a high gradation is supplied. It is assumed here that an image signal of a high gradation is used so that the display screen emits light with a uniform luminance.

A display screen image 831 represents a display example in the case where an image signal which is not corrected is supplied. Meanwhile, a ghosting display region 832 represents a region corresponding to pixel circuits of the display screen image 831 with which ghosting appears, that is, corresponding to those pixel circuits which suffer much from degradation. In FIG. 8A, in the ghosting display region 832, the characters “ABCD” are indicated in gray. Meanwhile, a region of the display screen image 831 other than the ghosting display region 832, that is, a region indicated by the blank, corresponds to those pixel circuits which suffer little from degradation. In this manner, in the case where the image signal is not corrected, the luminance of the degraded pixel circuits drops, and therefore, the characters “ABCD” are displayed in the ghosting display region 832.

A display screen image 833 indicates a display example in the case where a corrected image signal is supplied. Further, a ghosting display region 834 represents a region corresponding to the ghosting display region 832 of the display screen image 831. Here, if correction of the degradation of the conversion efficiency is not carried out for the ghosting display region 832, then the characters “ABCD” which are indicated in gray on the display screen image 831 are displayed. However, if the pixel circuits which suffer much from degradation are corrected so that the luminance of emitted light therefrom becomes equal to the luminance of the pixel circuits in the initial state, then the luminance of the pixel circuits becomes equal to the luminance of light emitted from those pixel circuits of the display screen image 833 which suffer little from degradation. Therefore, the characters “ABCD” are not displayed in the ghosting display region 834. It is to be noted that also the luminance of emitted light from the pixel circuits of the display screen image 833 which suffer little from degradation is corrected so as to be equal to the luminance of the pixel circuits in the initial state.

By correcting the image signal in high gradations in this manner, the luminance of emitted light from those pixel circuits which suffer much from degradation and the luminance of emitted light from those pixel circuits which suffer little from degradation are corrected with a high degree of accuracy so that they may be equal to the luminance of the pixel circuits in the initial state. Consequently, ghosting can be eliminated.

FIG. 8B illustrates a comparative example of the display screen after correction in the case where an image signal of a low luminance is supplied. It is assumed here that an image signal of a low luminance is used so that the entire display screen emits light with a uniform luminance.

A display screen image 835 represents a display example in the case where an image signal which is not corrected is supplied. Meanwhile, a ghosting display region 836 represents a region corresponding to pixel circuits of the display screen image 835 with which ghosting appears, that is, corresponding to those pixel circuits which suffer much from degradation. In FIG. 8B, in the ghosting display region 836, the characters “ABCD” are indicated in dark gray. Meanwhile, a region of the display screen image 835 other than the ghosting display region 836, that is, a region indicated by light gray, corresponds to those pixel circuits which suffer little from degradation. In this manner, in the case where the image signal is not corrected, the luminance of the degraded pixel circuits drops, and therefore, the characters “ABCD” are displayed in the ghosting display region 836 similarly as in the case of FIG. 8A.

A display screen image 837 indicates a display example in the case where a corrected image signal is supplied. Further, a ghosting display region 838 represents a region corresponding to the ghosting display region 836 of the display screen image 835. Here, if correction of the degradation of the conversion efficiency is not carried out for the ghosting display region 836, then the characters “ABCD” which are indicated in rather dark gray on the display screen image 831 are displayed. In the ghosting display region 838, although the image signal is corrected, the luminance of emitted light from the pixel circuits which suffer much from degradation is not corrected so that it becomes equal to the luminance of the pixel circuits in the initial state. Therefore, the characters “ABCD” are displayed in the ghosting display region 838. It is to be noted that, since also the luminance of emitted light from those pixel circuits of the display screen image 837 which suffer little from degradation is not corrected so as to be equal to the luminance of the pixel circuits in the initial state, it is lower than the luminance of the pixel circuits in the initial state.

In this manner, correction of the image signal in a low gradation fails to correct the luminance of emitted light from those pixel circuits which suffer much from degradation and the luminance of emitted light from those pixel circuits which suffer little from degradation so as to be equal to the luminance of the pixel circuits in the initial state. Consequently, in the case where only correction of degradation of the conversion efficiency is carried out, if the correction with regard to ghosting in a high gradation is carried out with a high degree of accuracy, then ghosting arising from an image signal in a low luminance is not eliminated.

In this manner, if only correction of degradation of the conversion efficiency is carried out, correction of ghosting cannot be carried out with a high degree of accuracy with regard to all gradations of the image signal. Therefore, the first embodiment of the present invention provides an example wherein ghosting arising from an image signal of a high gradation is corrected and correction of ghosting with regard to all gradations of an image signal is carried out with a high degree of accuracy.

### Example of the Configuration of the Ghosting Correction Section

FIG. 9 is a block diagram showing an example of a functional configuration of the ghosting correction section 200 in the first embodiment of the present invention. Referring to FIG. 9, the ghosting correction section 200 includes a conversion efficiency degradation information integration unit 220, a conversion efficiency degradation correction pattern production unit 230, a current amount decrease information integration unit 320, a current amount decrease correction pattern production unit 330 and a correction calculation unit 340. It is to be noted that the ghosting correction section 200 in the first embodiment of the present invention is an example of a signal processing apparatus and a signal processing circuit according to the present invention.

Here, in the first embodiment of the present invention, it is assumed that an image signal is corrected so that a pixel characteristic of any of the pixel circuits 600 to 608 which suffers from degradation may coincide with a reference for correction for which a pixel characteristic of a pixel circuit in an initial state which does not suffer from degradation is used.

Also it is assumed for the convenience of description that, in the ghosting correction section 200 in the first embodiment of the present invention, information retained in the conversion efficiency degradation information integration unit 220 and the current amount decrease information integration unit 320 is updated by acquiring a corrected image signal for each frame at intervals of one minute. Furthermore, it is assumed for the convenience of description that, every time the information retained in the conversion efficiency degradation information integration unit 220 and the current amount decrease information integration unit 320 is updated, the conversion efficiency degradation correction pattern production unit 230 and the current amount decrease correction pattern production unit 330 produce a new correction pattern.

The conversion efficiency degradation information integration unit 220 retains information regarding degradation of the conversion efficiency of the luminance of the pixel circuits 600 to 608, that is, conversion efficiency degradation information and successively updates the conversion efficiency degradation information. Further, the conversion efficiency degradation information integration unit 220 successively adds new degradation amounts of the light conversion efficiency of the pixel circuits 600 to 608 to the conversion efficiency degradation information to update the conversion efficiency degradation information. Here, the conversion efficiency degradation information is a value obtained, for example, by converting the amounts of conversion efficiency degradation of the pixel circuits 600 to 608 into light emission time periods by an image signal of a particular gradation value. The conversion efficiency degradation information integration unit 220 includes a conversion efficiency degradation information updating section 221 and a conversion efficiency degradation information retaining section 222.

The conversion efficiency degradation information updating section 221 updates the conversion efficiency degradation information retained in the conversion efficiency degradation information retaining section 222 by adding the value of new degradation of the conversion efficiency of the pixel circuits 600 to 608. In particular, the conversion efficiency degradation information updating section 221 calculates information regarding new degradation of the conversion efficiency of the pixel circuits 600 to 608, for example, based on an image signal after correction supplied thereto from the correction calculation unit 340 using a coefficient degradation conversion coefficient. Here, the coefficient degradation conversion coefficient is a coefficient for converting the degradation amount of the light emitting element 640, for example, in accordance with lapse of time based on light emission time and the gradation upon light emission.

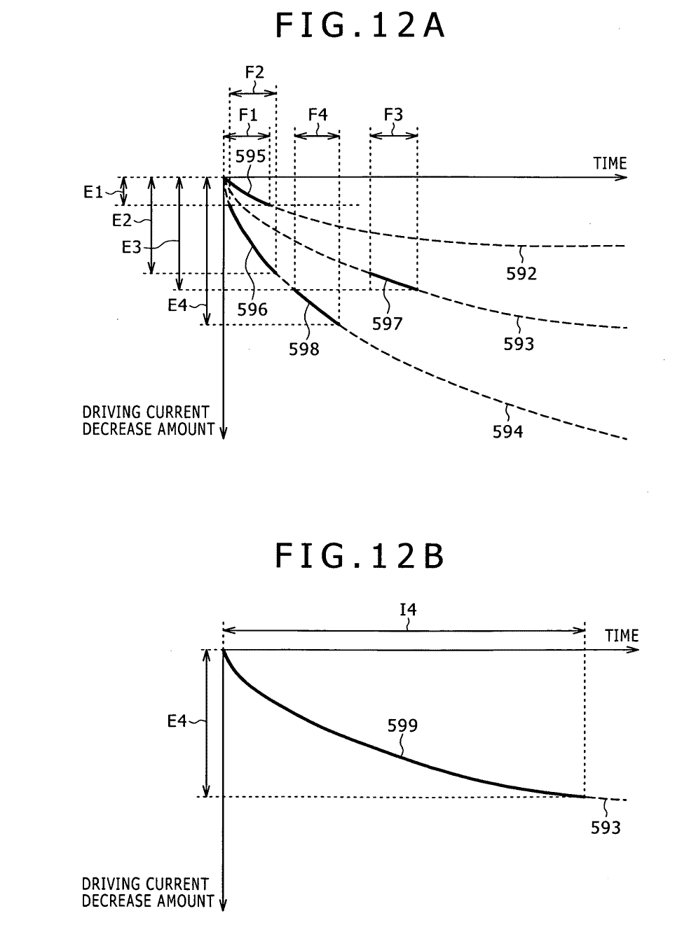

Then, the conversion efficiency degradation information updating section 221 successively adds the information regarding new degradation to the conversion efficiency degradation information to produce updated conversion efficiency degradation information. The conversion efficiency degradation information updating section 221 supplies the updated conversion efficiency degradation information to the conversion efficiency degradation information retaining section 222. It is to be noted that an example of production of updated conversion efficiency degradation information is hereinafter described with reference to FIG. 12.

The conversion efficiency degradation information retaining section 222 retains conversion efficiency degradation information and particularly retains the conversion efficiency degradation information of the pixel circuits 600 to 608 for the individual pixel circuits. Further, every time updated conversion efficiency degradation information is supplied from the conversion efficiency degradation information updating section 221, the conversion efficiency degradation information retaining section 222 successively retains the updated conversion efficiency degradation information. The conversion efficiency degradation information retaining section 222 supplies the retained conversion efficiency degradation information to the conversion efficiency degradation information updating section 221 and the conversion efficiency degradation correction pattern production unit 230. It is to be noted that the conversion efficiency degradation information retaining section 222 is an example of a conversion efficiency degradation information retaining section.

The conversion efficiency degradation correction pattern production unit 230 produces a pattern for correcting conversion efficiency degradation, that is, a conversion efficiency degradation correction pattern. Here, the conversion efficiency degradation correction pattern is a correction pattern configured from correction values for conversion efficiency degradation, that is, conversion efficiency degradation values, for the pixel circuits 600 to 608 and is correction information for correcting the conversion efficiency degradation. The conversion efficiency degradation correction pattern production unit 230 includes a reference conversion efficiency value supplying section 231, a target conversion efficiency value production section 232, a conversion efficiency degradation value calculation section 233 and a conversion efficiency degradation correction pattern retaining section 234. It is to be noted that the conversion efficiency degradation correction pattern production unit 230 is an example of a conversion efficiency degradation value calculation section.

The reference conversion efficiency value supplying section 231 supplies an efficiency coefficient for a pixel circuit to be used as a reference in correction of conversion efficiency degradation as a reference conversion efficiency value. For example, in the first embodiment of the present invention, the reference conversion efficiency value supplying section 231 retains an efficiency coefficient for a pixel circuit in a state in which it does not suffer from degradation, that is, in an initial state, and supplies the retained efficiency coefficient as a reference conversion efficiency value. The reference conversion efficiency value supplying section 231 supplies the reference conversion efficiency value to the conversion efficiency degradation value calculation section 233.

The target conversion efficiency value production section 232 supplies an efficiency coefficient for a pixel circuit to be determined as a target of production of a conversion efficiency degradation value as a target conversion efficiency value. For example, the target conversion efficiency value production section 232 successively acquires conversion efficiency degradation information regarding the pixel circuits 600 to 608 from the conversion efficiency degradation information retaining section 222. The target conversion efficiency value production section 232 uses coefficient conversion information to calculate the efficiency coefficient for the pixel circuit from the acquired conversion efficiency degradation information. The target conversion efficiency value production section 232 supplies, the calculated efficiency coefficient as a target conversion efficiency value to the conversion efficiency degradation value calculation section 233. Here, the coefficient conversion information is, for example, where the value obtained by conversion into a light emission time period based on an image signal of a particular gradation value is the conversion efficiency degradation information, information indicative of a correlation between the light emission time period and the efficiency coefficient.

The conversion efficiency degradation value calculation section 233 calculates a conversion efficiency degradation value for each of the pixel circuits 600 to 608 based on the reference conversion efficiency value and the target conversion efficiency value in order to produce a conversion efficiency degradation correction pattern. The conversion efficiency degradation value calculation section 233 calculates the conversion efficiency degradation value ΔA described hereinabove with reference to FIGS. 7A and 7B based on the target conversion efficiency value and the reference conversion efficiency value. For example, the conversion efficiency degradation value is calculated by division wherein the target conversion efficiency value is the numerator and the reference conversion efficiency value is the denominator. The conversion efficiency degradation value calculation section 233 produces the conversion efficiency degradation value for all of the pixel circuits 600 to 608. The conversion efficiency degradation value calculation section 233 supplies the produced conversion efficiency degradation values to the conversion efficiency degradation correction pattern retaining section 234.

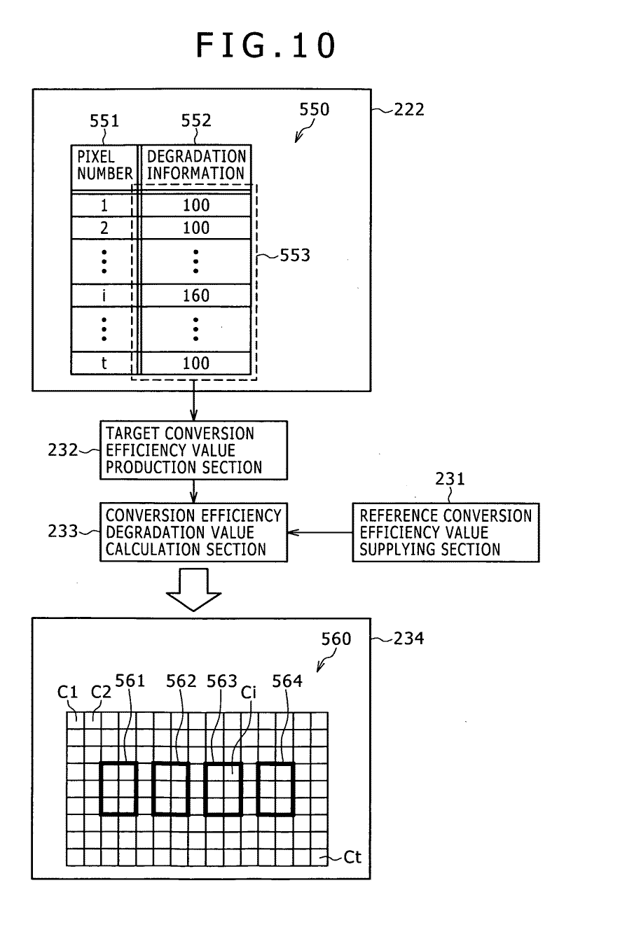

The conversion efficiency degradation correction pattern retaining section 234 retains the conversion efficiency degradation values supplied thereto from the conversion efficiency degradation value calculation section 233 for the individual pixel circuits. In the following description, the conversion efficiency degradation values configured for the individual pixel circuits are referred to connectively as conversion efficiency degradation correction pattern such as, for example, a conversion efficiency degradation correction pattern (n) 560 shown in FIG. 10. The conversion efficiency degradation correction pattern retaining section 234 supplies the conversion efficiency degradation correction pattern retained therein to the correction calculation unit 340.

The current amount decrease information integration unit 320 retains information regarding decrease of the current amount of driving current of the pixel circuits 600 to 608 as current amount decrease information, and integrates the new decrease amount of driving current of the pixel circuits 600 to 608 into current amount decrease information to update the current amount decrease information. Here, the current amount decrease information is a value obtained, for example, by converting the decrease amount of driving current of the pixel circuits 600 to 608 into a light emission time period by an image signal of a particular gradation value. The current amount decrease information integration unit 320 includes a current amount decrease information updating section 321 and a current amount decrease information retaining section 322.

The current amount decrease information updating section 321 integrates a new decrease amount of driving current of the pixel circuits 600 to 608 to update the current amount decrease information retained in the current amount decrease information retaining section 322. The current amount decrease information updating section 321 calculates information regarding a new decrease amount of the pixel circuits 600 to 608 using a decrease amount conversion coefficient, for example, based on the image signal after correction supplied thereto from the correction calculation unit 340. Here, the reduction amount conversion coefficient is a coefficient for converting the decrease amount of the current amount of driving current together with lapse of time based on the light emission time period and the gradation upon light emission.

Further, the current amount decrease information updating section 321 successively adds information regarding the new decrease amount to the current amount decrease information to produce updated current amount decrease information. The current amount decrease information updating section 321 supplies the updated current amount decrease information to the current amount decrease information retaining section 322. It is to be noted that an example of production of updated current amount decrease information is hereinafter described in detail with reference to FIG. 12.

The current amount decrease information retaining section 322 retains current amount decrease information and particularly retains current amount decrease information of the pixel circuits 600 to 608 for the individual pixel circuits. Further, every time updated current amount decrease information is supplied from the current amount decrease information updating section 321, the current amount decrease information retaining section 322 successively retains the updated current amount decrease information. The current amount decrease information retaining section 322 supplies the current amount decrease information retained therein to the current amount decrease information updating section 321 and the current amount decrease correction pattern production unit 330. It is to be noted that an example of the current amount decrease information is hereinafter described in detail with reference to FIG. 10. It is to be noted that the current amount decrease information retaining section 322 is an example of a current amount degradation information retaining section.

The current amount decrease correction pattern production unit 330 produces a pattern for correcting the driving current decrease amount, that is, a current amount decrease correction pattern. Here, the current amount reduction correction pattern is a correction pattern formed from correction values for the driving current decrease amounts of the pixel circuits 600 to 608, that is, from current amount degradation values and is correction information for correcting the driving current decrease amounts. The current amount decrease correction pattern production unit 330 includes a target current amount decrease value production section 332, a current amount degradation value calculation section 333 and a current amount decrease correction pattern retaining section 334.

The target current amount decrease value production section 332 supplies a target current amount decrease value of a pixel circuit which is a target of production of a current amount degradation value. For example, the target current amount decrease value production section 332 successively acquires current amount decrease information regarding the pixel circuits 600 to 608 from the current amount decrease information retaining section 322. Then, the target current amount decrease value production section 332 uses decrease amount conversion information to calculate the driving current decrease value ΔS, described hereinabove with reference to FIG. 7, of the pixel circuit from the acquired current amount decrease information. Here, the decrease amount conversion information is, for example, in the case where a value obtained by conversion into a light emission time period by an image signal of a particular gradation value is conversion efficiency degradation information, information indicative of a correlation between the light emission time period and the current amount decrease information. The target current amount decrease value production section 332 supplies the calculated driving current decrease amount as a target current amount decrease amount to the current amount degradation value calculation section 333.

The current amount degradation value calculation section 333 calculates a current amount degradation value for each of the pixel circuits 600 to 608 based on the target current decrease value in order to produce a current amount decrease correction pattern. First, the current amount degradation value calculation section 333 calculates a current amount degradation value from the target current amount decrease value. For example, if a driving current decrease amount is supplied as a target current amount decrease value, then the current amount degradation value calculation section 333 supplies the driving current decrease amount as a current amount degradation value. Here, the current amount degradation value is a value for varying the gradation value of the image signal supplied to the pixel circuit which is a target of correction of the driving current decrease amount to eliminate the difference in driving current decrease amount between the pixel circuit of the correction target and the pixel circuit of the correction reference. For example, the current amount degradation value is, in the first embodiment of the present invention in which a pixel circuit in an initial state is determined as a reference, the driving current decrease amount ΔS described hereinabove with reference to FIGS. 7A and 7B. The current amount degradation value calculation section 333 produces a current amount degradation value with regard to all of the pixel circuits 600 to 608 and supplies the produced current amount degradation values to the current amount decrease correction pattern retaining section 334. It is to be noted that the current amount degradation value calculation section 333 is an example of a current amount degradation value calculation section.

The current amount decrease correction pattern retaining section 334 retains a current amount degradation value supplied thereto from the current amount degradation value calculation section 333 for each pixel circuit. The current amount degradation values provided by the pixel circuits are hereinafter referred to as current amount decrease correction pattern. The current amount decrease correction pattern retaining section 334 retains the current amount degradation values of all of the pixel circuits 600 to 608 to retain the current amount decrease correction pattern formed from the current amount degradation values of all of the pixel circuits 600 to 608. The current amount decrease correction pattern retaining section 334 supplies the current amount decrease correction pattern retained therein to the correction calculation unit 340. It is to be noted that an example of the current amount decrease correction pattern is hereinafter described with reference to FIG. 10.

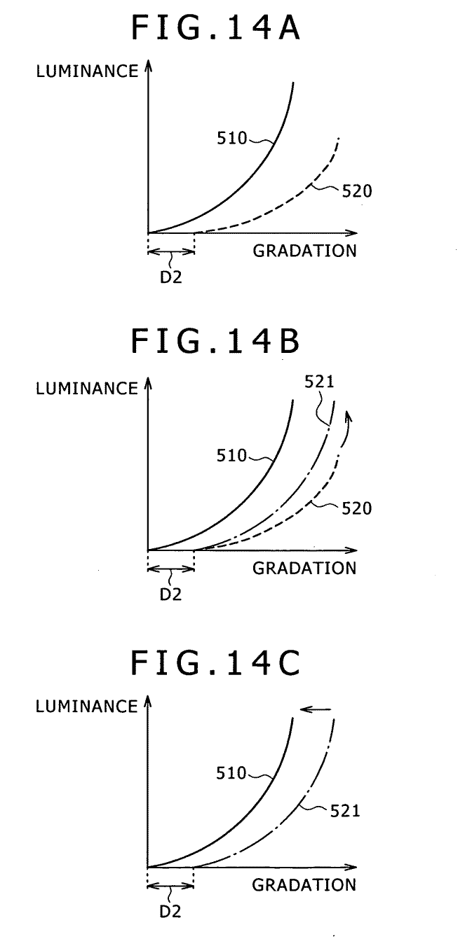

The correction calculation unit 340 corrects the image signal inputted thereto through a signal line 301 and supplies the corrected image signal to the conversion efficiency degradation information integration unit 220, current amount decrease information integration unit 320 and horizontal selector (HSEL) 420 through the signal line 209. The correction calculation unit 340 includes a conversion efficiency degradation correction calculation section 341 and a current amount degradation correction calculation section 342. It is to be noted that an example of the substance of the correction by the correction calculation unit 340 is hereinafter described in detail with reference to FIGS. 14A to 14C. Also it is to be noted that the correction calculation unit 340 is an example of a correction section.

The conversion efficiency degradation correction calculation section 341 corrects conversion efficiency degradation by varying the gradation value of the image signal inputted through the signal line 301 based on the conversion efficiency degradation correction pattern supplied thereto from the conversion efficiency degradation correction pattern retaining section 234. The conversion efficiency degradation correction calculation section 341 supplies the corrected image signal to the current amount degradation correction calculation section 342.

The current amount degradation correction calculation section 342 corrects the driving current decrease amount by varying the gradation value of the image signal outputted from the conversion efficiency degradation correction calculation section 341 based on the current amount decrease correction pattern supplied thereto from the current amount decrease correction pattern retaining section 334. The current amount degradation correction calculation section 342 supplies the corrected image signal to the conversion efficiency degradation information integration unit 220, current amount decrease information integration unit 320 and horizontal selector (HSEL) 420 through the signal line 209.

In this manner, correction regarding decrease of the driving current in the pixel circuits 600 to 608 can be carried out by providing the current amount decrease information integration unit 320 and the current amount decrease correction pattern production unit 330 in the ghosting correction section 200.

It is to be noted here that, while an image signal corrected with regard to each frame is acquired at intervals of one minute to update information retained in the conversion efficiency degradation information integration unit 220 and the current amount decrease information integration unit 320, the present invention is not limited to this. For example, a corrected image signal may be acquired at intervals of 10 minutes to update conversion efficiency degradation assuming that light is emitted for 10 minutes based on the acquired image signal. By setting the updating interval of the conversion efficiency degradation information to a comparatively long time period in this manner, the calculation amount can be reduced further. Also it is possible to update the information with a higher degree of accuracy by setting a shorter acquisition time interval of the corrected image signal for each frame by the conversion efficiency degradation information integration unit 220 and the current amount decrease information integration unit 320.

Further, while the conversion efficiency degradation correction pattern production unit 230 and the current amount decrease correction pattern production unit 330 update a correction pattern retained therein every time conversion efficiency degradation information and current amount decrease information are updated, respectively, the present invention is not limited to this. For example, the conversion efficiency degradation correction pattern and the current amount decrease correction pattern are not updated to much different patterns by updating at short intervals. This is because, even if the luminance disperses among different pixel circuits, the degradation progresses slowly. Therefore, it is a possible idea to acquire the conversion efficiency degradation information and the current amount decrease information at intervals of one hour and update the correction patterns based on the acquired information at intervals of one hour to decrease the calculation amount.

It is to be noted here that, while the conversion efficiency degradation information and the current amount decrease information are updated using the efficiency degradation conversion coefficients and the decrease amount conversion coefficients retained already in the conversion efficiency degradation information updating section 221 and the current amount decrease information updating section 321, respectively, the present invention is not limited to this. For example, a dummy pixel which emits light of a particular gradation value and allows measurement of degradation of a pixel circuit by the light emission of the dummy pixel may be provided such that an efficiency degradation conversion coefficient and a decrease amount conversion coefficient are produced based on the measurement. By measuring the degradation of the pixel circuit, an efficiency degradation conversion coefficient and a decrease amount conversion coefficient which reflect an actual use state of the display apparatus 100 can be produced. This makes it possible to obtain conversion efficiency degradation information and current amount decrease information which are accurate in comparison with an alternative case in which an efficiency degradation conversion coefficient and a decrease amount conversion coefficient retained already are used.

Further, while the conversion efficiency degradation information and the current amount decrease information are assumed to be values obtained by conversion into light emission time periods by an image signal of a particular gradation value, the present invention is not limited to this. Since the conversion efficiency degradation information and the current amount decrease information are values representative of degrees of degradation of the conversion efficiency and the driving current decrease amount, for example, ratios of degradation from the initial state may be used. Further, an efficiency coefficient and a driving current decrease amount may be calculated and retained as the conversion efficiency degradation information and the current amount decrease information, respectively.

Now, an example of production of a current amount decrease correction pattern by the current amount decrease correction pattern production unit 330 is described with reference to the drawings.

### Example of Production of a Conversion Efficiency Degradation Correction Pattern

FIG. 10 illustrates an example of production of a conversion efficiency degradation correction pattern by the conversion efficiency degradation value calculation section 233 in the first embodiment of the present invention. Particularly, FIG. 10 schematically illustrates a flow of operations until a conversion efficiency degradation correction pattern of the conversion efficiency degradation correction pattern retaining section 234 is produced based on the conversion efficiency degradation information retained in the conversion efficiency degradation information retaining section 222. It is to be noted that the pixel circuits provided in the display apparatus 100 are identified by characters 1 to t for the convenience of illustration and description.

Conversion efficiency degradation information (n−1) 550 is retained in the conversion efficiency degradation information retaining section 222. In the example illustrated in FIG. 10, the conversion efficiency degradation information is that retained in the conversion efficiency degradation information retaining section 222 based on display for one minute for the n−1th time (n is an integer equal to or greater than 2). This conversion efficiency degradation information (n−1) is used to produce a conversion efficiency degradation correction pattern (n) 560 for correcting display within one minute for the nth time. In the left side column (pixel number 551) in the conversion efficiency degradation information (n−1) 550, the pixel numbers “1,” “2,” “i” and “t” which are numbers of the pixel circuits which configure the screen are shown.

Further, in the right side column (degradation information 552) in the conversion efficiency degradation information (n−1) 550, conversion efficiency degradation information (degradation information) regarding the pixel circuits of the pixel numbers is indicated. It is assumed here that the pixel circuit corresponding to “i” of the pixel number 551 suffers comparatively much from degradation while the pixel circuits corresponding to “1,” “2” and “t” of the pixel number 551 suffer comparatively little from degradation. For example, it is assumed that time of “160” hours is retained as the conversion efficiency degradation information corresponding to “i” of the pixel number 551, and time of “100” hours is retained as the conversion efficiency degradation information corresponding to “1,” “2” and “t” of the pixel number 551.

The degradation information 552 (indicated in a broken line rectangle 553) retained in the conversion efficiency degradation information (n−1) 550 is updated by the conversion efficiency degradation information updating section 221 and acquired by the target conversion efficiency value production section 232.

In the case where such conversion efficiency degradation information (n−1) 550 as described above is retained in the conversion efficiency degradation information retaining section 222, the conversion efficiency degradation correction pattern production unit 230 carries out updating of the conversion efficiency degradation correction pattern for the nth time.

First, the target conversion efficiency value production section 232 acquires conversion efficiency degradation information regarding a pixel circuit which is a target of correction and supplies a target conversion efficiency value to the conversion efficiency degradation value calculation section 233 based on the acquired conversion efficiency degradation information. Here, as an example, a process in which the target conversion efficiency value of “1” of the pixel number 551 is supplied to the conversion efficiency degradation value calculation section 233 is described. First, the conversion efficiency degradation value calculation section 233 acquires the “100” hours of the degradation information 552 of “1” of the pixel number 551 and calculates an efficiency coefficient (here, represented by “h”) using the coefficient conversion information. Then, the calculated efficiency coefficient “h” is supplied as a target conversion efficiency value to the conversion efficiency degradation value calculation section 233.

Thereafter, the conversion efficiency degradation value calculation section 233 produces a conversion efficiency degradation value for each pixel circuit based on the reference conversion efficiency value and the target conversion efficiency value. For example, in the case where “g” is supplied as the reference conversion efficiency value from the reference conversion efficiency value supplying section 231, “h/g” is produced as the conversion efficiency degradation value.

Now, a conversion efficiency degradation correction pattern configured from conversion efficiency degradation values of the pixel circuits produced by the conversion efficiency degradation value calculation section 233 is described.

The conversion efficiency degradation correction pattern (n) 560 schematically represents a conversion efficiency degradation correction pattern produced by the conversion efficiency degradation value calculation section 233. In the example shown in FIG. 10, a conversion efficiency degradation correction pattern in the case where conversion efficiency degradation values for the individual pixel circuits produced by the conversion efficiency degradation value calculation section 233 are disposed in accordance with the disposition of pixels which configure the display screen is schematically represented. In particular, the conversion efficiency degradation correction pattern (n) 560 is an example of a correction pattern configured from conversion efficiency degradation values produced based on the conversion efficiency degradation information (n−1). Further, the conversion efficiency degradation correction pattern (n) 560 is a conversion efficiency degradation correction pattern updated for the nth time and provided to correct an image signal regarding frames to be displayed within a period of one minute for the nth time.

A conversion efficiency degradation value C1 in the conversion efficiency degradation correction pattern (n) 560 is a conversion efficiency degradation value for correcting the pixel circuit corresponding to “1” of the pixel number 551 in the conversion efficiency degradation information (n−1) 550. Further, the position of the conversion efficiency degradation value C1 in the conversion efficiency degradation correction pattern (n) 560 corresponds to the position of the pixel circuit corresponding to “1” of the pixel number 551 on the display screen. Further, also the conversion coefficient degradation values C2, Ci and Ct are those for correcting an image signal supplied to the pixel circuits corresponding to the pixel numbers 2, i and t indicated in the conversion efficiency degradation information (n−1) 550 similarly to the conversion efficiency degradation value C1. Further, the positions of the conversion coefficient degradation values C2, Ci and Ct in the conversion efficiency degradation correction pattern (n) 560 correspond to the positions of the pixel circuits corresponding to “2,” “i” and “t” of the pixel number 551 on the display screen, respectively.

Further, pixel regions 561 to 564 of the conversion efficiency degradation correction pattern (n) 560 represent regions in which conversion efficiency degradation values for making the gradation value of the image signal higher than those of the pixel circuits other than the pixel regions 561 to 564 are disposed. Further, the pixel circuits other than the pixel regions 561 to 564 represent regions in which conversion efficiency degradation values which make the gradation value of the image signal higher a little. In other words, the pixel regions 561 to 564 indicate regions in which a conversion efficiency degradation value regarding a pixel circuit which suffers from much degradation is disposed, and the pixel circuits other than the pixel regions 561 to 564 indicate regions in which a conversion efficiency degradation value regarding a pixel circuit which suffers a little from degradation is disposed.

In this manner, the conversion efficiency degradation value calculation section 233 produces a conversion efficiency degradation value for varying the gradation value of an image signal displayed by each pixel circuit in response to the degree of the driving current decrease amount of the pixel circuit. Then, since the conversion efficiency degradation value is produced with regard to all pixel circuits, correction of the pixel circuits which configure the display screen can be carried out appropriately.

### Example of Production of a Current Amount Decrease Correction Pattern

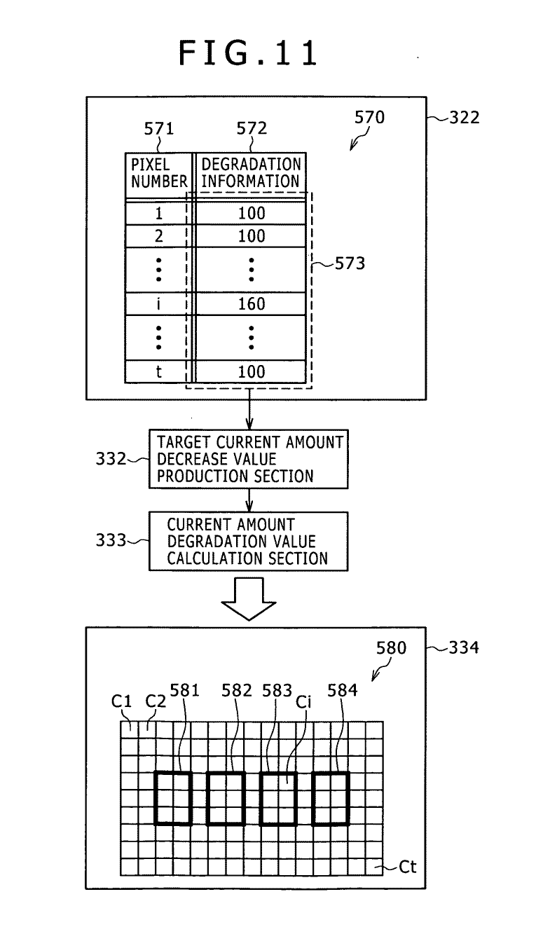

FIG. 11 illustrates an example of production of a current amount decrease correction pattern by the current amount degradation value calculation section 333 in the first embodiment of the present invention. More particularly, FIG. 11 schematically illustrates a flow of operation until a current amount decrease pattern of the current amount decrease correction pattern retaining section 334 is produced based on the current amount decrease information retained in the current amount decrease information retaining section 322. It is to be noted here that the pixel circuits provided in the display apparatus 100 are identified with reference characters 1 to t for the convenience of illustration and description.

Current amount decrease information (n−1) 570 is retained in the current amount decrease information retaining section 322. In the example illustrated in FIG. 11, the current amount decrease information is that retained in the current amount decrease information retaining section 322 based on display for one minute for the n−1th time (n is an integer equal to or greater than 2). This current amount decrease information (n−1) is used to produce a current amount decrease correction pattern (n) for correcting display within one minute for the nth time. In the left side column (pixel number 571) in the current amount decrease information (n−1) 570, the pixel numbers “1,” “2,” “i” and “t” which are numbers of the pixel circuits which configure the screen are shown. Further, in the right side column (decrease information 572) in the current amount decrease information (n−1) 570, current amount decrease information (degradation information) regarding the pixel circuits of the pixel numbers is indicated. It is assumed here that the pixel circuit corresponding to “i” of the pixel number 571 suffers comparatively much from degradation while the pixel circuits corresponding to “1,” “2” and “t” of the pixel number 571 suffer comparatively little from degradation. For example, it is assumed that time of “160” hours is retained as the current amount decrease information corresponding to “i” of the pixel number 571, and time of “100” hours is retained as the current amount decrease information corresponding to “1,” “2” and “t” of the pixel number 571.

The decrease information 572 (indicated in a broken line rectangle 573) retained in the current amount decrease information (n−1) 570 is updated by the current amount decrease information updating section 321 and acquired by the target current amount decrease value production section 332.

In the case where such current amount decrease information (n−1) 570 as described above is retained in the current amount decrease information retaining section 322, the current amount decrease, correction pattern production unit 330 carries out nth time updating of the current amount decrease correction pattern.

First, the target current amount decrease value production section 332 acquires current amount decrease information regarding a pixel circuit which is a target of correction and supplies a target current decrease value to the current amount degradation value calculation section 333 based on the acquired current amount decrease information. It is to be noted that a process of the target current amount decrease value production section 332 for calculating a target current amount decrease value from the current amount decrease information using the decrease amount decrease information is hereinafter described with reference to FIGS. 14A to 14C.

Here, as an example, a process in which a target current decrease value of “1” of the pixel number 571 is supplied to the current amount degradation value calculation section 333 is described. First, the target current amount decrease value production section 332 acquires time of “100” hours of the decrease information 572 of “1” of the pixel number 571 and calculates a driving current decrease amount (here, represented by “j”) using the decrease amount conversion information. Then, the calculated driving current decrease amount j is supplied as a target current decrease value to the current amount degradation value calculation section 333.

Thereafter, the current amount degradation value calculation section 333 produces a current amount degradation value for each pixel circuit. For example, in the case where “j” is supplied as the target current amount decrease value from the target current amount decrease value production section 332, “j” is produced as the current amount degradation value.

Now, a current amount decrease correction pattern configured from current amount degradation values of the pixel circuits produced by the current amount degradation value calculation section 333 is described.

The current amount decrease correction pattern (n) 580 schematically represents a current amount decrease correction pattern produced by the current amount degradation value calculation section 333. In the example shown in FIG. 11, a current amount decrease correction pattern in the case where current amount degradation values for the individual pixel circuits produced by the current amount degradation value calculation section 333 are disposed in accordance with the disposition of the pixels which configure the display screen is schematically represented. In particular, the current amount decrease correction pattern (n) 580 is an example of a correction pattern configured from current amount degradation values produced based on the current amount decrease information (n−1). Further, the current amount decrease correction pattern (n) 580 is a pattern updated for the nth time and provided to correct an image signal regarding frames to be displayed within a period of one minute for the nth time.

The current amount decrease value C1 in the current amount decrease correction pattern (n) 580 is a current amount degradation value for correcting the pixel circuit corresponding to “1” of the pixel number 571 in the current amount decrease information (n−1) 570. Further, the position of the current amount decrease value C1 in the current amount decrease correction pattern (n) 580 corresponds to the position of the pixel circuit corresponding to “1” of the pixel number 571 on the display screen. Also the current amount decrease values C2, Ci and Ct are those for correcting image signals supplied to the pixel circuits corresponding to the pixel numbers 2, i and t indicated in the current amount decrease information (n−1) 570 similarly to the current amount decrease value C1. Further, the positions of the current amount decrease values C2, Ci and Ct in the current amount decrease correction pattern (n) 580 correspond to the positions of the pixel circuits corresponding to “2,” “i” and “t” of the pixel number 571 on the display screen, respectively.

Further, pixel regions 581 to 584 of the current amount decrease correction pattern (n) 580 represent regions in which current amount degradation values for making the gradation value of the image signal higher than those of the pixel circuits other than the pixel regions 581 to 584 are disposed. Further, the pixel circuits other than the pixel regions 581 to 584 represent regions in which current amount degradation values which make the gradation value of the image signal higher a little are disposed. In other words, the pixel regions 581 to 584 indicate regions in which a current amount degradation value regarding a pixel circuit which suffers from much degradation is disposed, and the pixel circuits other than the pixel regions 581 to 584 indicate regions in which a current amount degradation value regarding a pixel circuit which suffers a little from degradation is disposed.

In this manner, the current amount degradation value calculation section 333 produces a current amount degradation value for varying the gradation value of an image signal displayed by each pixel circuit in response to the degree of the driving current decrease amount of the pixel circuit. Then, since the current amount degradation value is produced with regard to all pixel circuits, correction of the pixel circuits which configure the display screen can be carried out appropriately.

### Example of Production of Current Amount Decrease Information

FIGS. 12A and 12B illustrates an example of production of current amount decrease information by the current amount decrease information updating section 321 in the first embodiment of the present invention.

Graphs shown in FIGS. 12A and 12B are used when the current amount decrease information updating section 321 produces current amount decrease information. It is to be noted that the graphs of FIGS. 12A and 12B are given assuming that the value of n illustrated in FIG. 11 is “5.” In particular, FIGS. 12A and 12B illustrate an example of production of current amount decrease information (4) for producing a current amount decrease correction pattern (5) for correcting display within a period of one minute for the fifth time. Further, in FIGS. 12A and 12B, a case in which a driving current amount decrease amount is calculated and the current amount decrease information (4) is produced based on the calculated driving current decrease amount is assumed.

The graphs shown in FIGS. 12A and 12B indicate decrease amount characteristics in the case where the axis of abscissa indicates the current amount decrease information, that is, the light emission time period, and the axis of ordinate indicates the driving current decrease amount. As an example of the decrease amount characteristic, in FIG. 12A, a decrease amount characteristic (gradation value 100) 592, a decrease amount characteristic (gradation value 150) 593 and a decrease amount characteristic (gradation value 200) 594 are indicated. Further, in FIG. 12A, it is assumed that, within one minute for the first time, the pixel circuit emits light in response to an image signal having a gradation value of “100,” and within one minute for the second time, the pixel circuit emits light with an image signal having another gradation value of “200.” Further, within one minute for the third time, the pixel circuit emits light in response to an image signal of a gradation value of “150,” and within one minute for the fourth time, the pixel circuit emits light in response to an image signal of another gradation value of “200.”

FIG. 12A illustrates an example of addition of a driving current decrease amount for producing the current amount decrease information (4).

The decrease amount characteristic (gradation value 100) 592 is a curve indicative of a relationship between the light emission time (time) upon light emission based on an image signal of the gradation value “100” and the driving current decrease amount. Meanwhile, the decrease amount characteristic (gradation value 150) 593 is a curve illustrating a relationship between the light emission time period (time) upon light emission based on an image signal of the gradation value of “150” and the driving current decrease amount. Further, the decrease amount characteristic (gradation value 200) 594 is a curve indicative of a relationship between the light emission time period (time) upon light emission based on an image signal of the gradation value of “200” and the driving current decrease amount.

Light emission periods (1) F1 to (4) F4 indicate periods for calculating degradation within one period for the first to fourth times.

Addition target values (1) 595 to (4) 597 indicate a relationship between the light emission periods (1) F1 to (4) F4 which are one-minute periods and the driving current decrease amount within the one-minute periods.

The driving current amount decrease amounts (1) E1 to (4) E4 indicate driving current amount decrease amounts within one- to four-minute periods calculated by successively adding the addition target values (1) 595 to (4) 597.

Here, a process until the driving current decrease amount (4) E4 calculated based on display within a period of one minute for the fourth time in order beginning with that within one minute for the first time.

First, within the period of one minute for the first time, a addition target value (1) 595 indicative of a decrease amount of driving current by degradation of the pixel circuit in an initial state is calculated based on the decrease amount characteristic (gradation value 100) 592 and the light emission period (1) F1. This addition target value (1) 595 indicates the driving current degradation amount within one minute caused by degradation of the pixel circuit in the initial state for one minute by an image signal of the gradation value “100.” By this, the decrease amount of the driving current, that is, the driving current decrease amount (1) E1, by light emission for one minute is calculated.

Further, within the period of one minute for the second time, a addition target value (2) 596 is calculated based on the decrease amount characteristic (gradation value 200) 594, the driving current decrease amount (1) E1 and the light emission period (2) F2. This addition target value (2) 596 indicates the driving current degradation amount for one minute caused by degradation of the pixel circuit for one minute, which is in a state degraded by the driving current decrease amount (1) E1, by an image signal of the gradation value “200.” By this, the driving current degradation amount indicated by the addition target value (2) 596 is added to the driving current decrease amount (1) E1 to calculate a decrease amount of the driving current by the light emission for two minutes, that is, a driving current decrease amount (2) E2.

Further, within the period of one minute for the third time, an addition target value (3) 597 is calculated based on the decrease amount characteristic (gradation value 150) 593, the driving current decrease amount (2) E2 and the light emission period (3) F3. This addition target value (3) 597 indicates the driving current degradation amount for one minute caused by degradation of the pixel circuit, which is in a state degraded by the driving current decrease amount (2) E2, for one minute by an image signal of the gradation value “150.” By this, the driving current degradation amount indicated by the addition target value (3) 597 is added to the driving current decrease amount (2) E2 to calculate a decrease amount of the driving current by light emission for three minutes, that is, a driving current decrease amount (3) E3.

Then, within the period of one minute for the fourth time, an addition target value (4) 598 is calculated based on the decrease amount characteristic (gradation value 200) 594, the driving current decrease amount (3) E3 and the light emission period (4) F4. By this, the driving current degradation amount indicated by the addition target value (4) 598 is added to the driving current decrease amount (3) E3 to calculate a decrease amount of the driving current by the light emission at the fourth time, that is a driving current decrease amount (4) E4.

FIG. 12B illustrates an example wherein a current amount decrease information (4) 14 is produced based on the driving current decrease amount (4) E4.

Here, it is assumed that the current amount decrease information retained in the current amount decrease information retaining section 322 is a light emission time period in the case where an image signal of the gradation value “150” is supplied to the pixel circuit.

An addition result value 599 indicates a correlation between the driving current decrease amount (4) E4 and the light emission period by an image signal of the gradation value “150,” that is, current amount decrease information (4) 14. In particular, the addition result value 599 indicates a correlation between a value obtained by adding all driving current decrease amounts indicated by the addition target values (1) 595 to (4) 597 and the light emission period by an image signal of the gradation value “150.”

By adding the decrease amounts of the driving current within the periods in this manner, a driving current decrease amount and current amount decrease information are obtained. For example, the current amount decrease information updating section 321 calculates current amount decrease information based on light emission for the n−1th time based on the gradation decrease amount characteristic for the n−1th time, the length of the period for the n−1th time and the current amount decrease information calculated based on the light emission for the n−2th time.

It is to be noted that, in the example described above with reference to FIGS. 12A and 12B, the current amount decrease information (4) 14 is calculated after the driving current decrease amount (4) E4 is calculated for the convenience of description. However, the current amount decrease information updating section 321 need not necessarily calculate the driving current decrease amount once. In the first embodiment of the present invention, it is assumed that the current amount decrease information updating section 321 produces updated current amount decrease information by converting an addition target value into a light emission time period of the gradation value “150” and successively adding the light emission time period to the current amount decrease information. It is to be noted that, in the case where driving current decrease information is produced using the method described hereinabove with reference to FIGS. 12A and 12B, the decrease amount conversion coefficient is a coefficient which indicates a decrease amount characteristic of each gradation.

Further, the conversion efficiency degradation information produced by the conversion efficiency degradation information updating section 221 is substantially similar to that in the example of production described hereinabove with reference to FIGS. 12A and 12B. If the graphs shown in FIGS. 12A and 12B are modified such that the axis of abscissa indicates the current amount decrease information, that is, the light emission time period, and the axis of ordinate indicates the conversion decrease degradation amount such that the curves individually represent characteristics regarding the conversion efficiency degradation of each gradation, then the conversion efficiency degradation information can be represented, and therefore, description of the same is omitted herein to avoid redundancy. It is to be noted that, in the case where the conversion efficiency degradation information is produced using the method described hereinabove with reference to FIGS. 12A and 12B, the efficiency degradation conversion coefficient is, for example, a coefficient indicative of a characteristic of conversion efficiency degradation of each gradation.

### Example of Production of a Target Current Amount Decrease Value

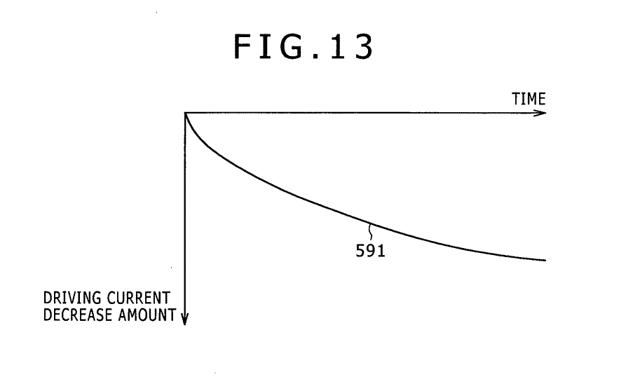

FIG. 13 illustrates an example of a relationship between the current amount decrease information, that is, the light emission time period, and the driving current decrease amount in the first embodiment of the present invention.

A graph shown in FIG. 13 is used when the target current amount decrease value production section 332 produces a target current amount decrease value. More particularly, the graph in FIG. 13 indicates a decrease amount characteristic (gradation value 150) 591 in the case where the axis of abscissa indicates the current value decrease information, that is, the light emission time period, and the axis of ordinate indicates the driving current decrease amount.

Here, it is assumed that the current amount decrease amount retained in the current amount decrease information retaining section 322 is a light emission time period in the case where an image signal of the gradation value “150” is supplied to a pixel circuit.

The decrease amount characteristic (gradation value 150) 591 is a curve indicative of a relationship between the current amount decrease information, that is, the light emission time period, and the driving current decrease amount. More particularly, the decrease amount characteristic (gradation value 150) 591 indicates a relationship between the light emission time period based on the 150th gradation value and the driving current decrease amount. In particular, the target current amount decrease value production section 332 can convert the current amount decrease information into a driving current decrease value by using the decrease amount conversion information which is information regarding the decrease amount characteristic (gradation value 150).

Further, the coefficient conversion information used by the target conversion efficiency value production section 232 can be represented by a graph obtained by modifying the graph shown in FIG. 13 such that the axis of abscissa indicates the conversion efficiency degradation information, that is, the time period, and the axis of ordinate indicates the degradation rate of the efficiency coefficient. Therefore, detailed description of the graph is omitted herein to avoid redundancy.

### Example of a Pixel Characteristic Curve of a Corrected Image Signal

FIGS. 14A to 14C illustrate a relationship between the gradation inputted to the ghosting correction section 200 in the first embodiment of the present invention and the luminance. The graphs shown in FIGS. 14A to 14C indicate pixel characteristic curves in which the axis of abscissa indicates the value of the gradation of the image signal inputted to the ghosting correction section 200, that is, of the input gradation value and the axis of ordinate indicates the value of the luminance of emitted light from the pixel circuits 600 to 608, that is, of the luminance value similarly as in FIGS. 7A and 7B. Also the input gradation value is similar to that in FIGS. 7A and 7B.

FIG. 14A illustrates a pixel characteristic of a pixel circuit in an initial state and a pixel characteristic of a degraded pixel circuit.

A reference pixel characteristic 510 is a curve indicative of a relationship between the input gradation value and the luminance value of a pixel circuit in an initial state. Since the reference pixel characteristic 510 is same as the pixel characteristic (initial) 810 illustrated in FIGS. 7A and 7B, overlapping description of the same is omitted herein to avoid redundancy.

A correction target pixel characteristic 520 is a curve indicative of a relationship between the input gradation value and the luminance value of a pixel circuit wherein the light emitting element is deteriorated by lapse of time. Since the correction target pixel characteristic 520 suffers from degradation of the efficiency in conversion of driving current into luminance of the light emitting element 640, that is, from conversion efficiency degradation, the gradient of the curve thereof is more moderate than that of the reference pixel characteristic 510. Further, the correction target pixel characteristic 520 exhibits a shift by an amount corresponding to a driving current amount decrease component D2 in the direction of the axis of abscissa which indicates the gradation value from that of the reference pixel characteristic 510. The correction target pixel characteristic 520 and the driving current amount decrease component D2 are similar to the pixel characteristic (correction target) 820 and the driving current amount decrease component D1 described hereinabove, respectively, and therefore, overlapping description of them is omitted herein to avoid redundancy.

FIG. 14B illustrates a pixel characteristic indicative of the substance of correction of conversion efficiency degradation by the conversion efficiency degradation correction calculation section 341 as a conversion efficiency correction substance curve 521.

The conversion efficiency correction substance curve 521 is a pixel characteristic indicative of the substance of correction of conversion efficiency degradation for an image signal supplied to a pixel circuit which has the pixel characteristic illustrated as the correction target pixel characteristic 520. The conversion efficiency correction substance curve 521 exhibits such a pixel characteristic that the gradient of the correction target pixel characteristic 520 is made substantially coincide with that of the reference pixel characteristic 510. Further, the conversion efficiency correction substance curve 521 exhibits such a pixel characteristic that, while it has the same gradient as that of the reference pixel characteristic 510, it is shifted by the driving current amount decrease component D2 in the direction of the axis of abscissa indicative of the gradation value.

In this manner, the correction by the conversion efficiency degradation correction calculation section 341 corresponds to correction of the gradient of a pixel characteristic.

FIG. 14C illustrates the substance of correction of the driving current decrease amount by the current amount degradation correction calculation section 342 after the correction by the conversion efficiency degradation correction calculation section 341. More particularly, FIG. 14C indicates that, by shifting the conversion efficiency correction substance curve 521 by the driving current amount decrease component D2 after correction corresponding to the correction of the gradient of the pixel characteristic, the pixel characteristic with respect to the input gradation value becomes same as the reference pixel characteristic 510.

Here, the substance of the correction by the conversion efficiency degradation correction calculation section 341 and the current amount degradation correction calculation section 342 in the first embodiment of the present invention is described. The correction by the conversion efficiency degradation correction calculation section 341 and the current amount degradation correction calculation section 342 is carried out by variation of the gradation indicated by the following expression 7:

Sₒᵤₜ=(ΔA)^{-1/2}×Sᵢₙ+ΔS expression 7

where Sₒᵤₜ and Sᵢₙ are similar to those described hereinabove with reference to FIG. 7B, and therefore, overlapping description of them is omitted herein to avoid redundancy. Meanwhile, ΔA is a value of a fraction A_{d}/A=ΔA representative of a ratio in conversion efficiency between the efficiency coefficient A_{d} of a correction target pixel circuit which exhibits the correction target pixel characteristic 520 as the numerator and the conversion efficiency A of the pixel circuit in the initial state which exhibits the reference pixel characteristic 510 as the denominator. In short, ΔA is a conversion efficiency degradation value produced by the conversion efficiency degradation value calculation section 233.

On the other hand, ΔS is the driving current decrease amount indicated as the driving current amount decrease component D2 of the correction target pixel circuit which exhibits the correction target pixel characteristic 520. In short, ΔS is a current amount degradation value produced by the current amount degradation value calculation section 333.

By carrying out correction by calculation using the expression 7 given hereinabove, the ghosting correction section 200 can carry out correction of the conversion efficiency degradation and the driving current decrease amount independently of each other and carry out correction in accordance with the pixel characteristic of the pixel circuit in the initial state with a high degree of accuracy.

In this manner, with the first embodiment of the present invention, an image signal can be corrected such that, whichever gradation value is inputted, the pixel characteristic is same as that of a reference pixel.

It is to be noted here that, while, in the example described above, the gradation value of the image signal is varied by calculating the expression 7, the present invention is not limited to this. Two factors of information regarding degradation of the conversion efficiency and information regarding decrease of the driving current amount may be used to correct ghosting by some other calculation method.

Example of Display after Correction

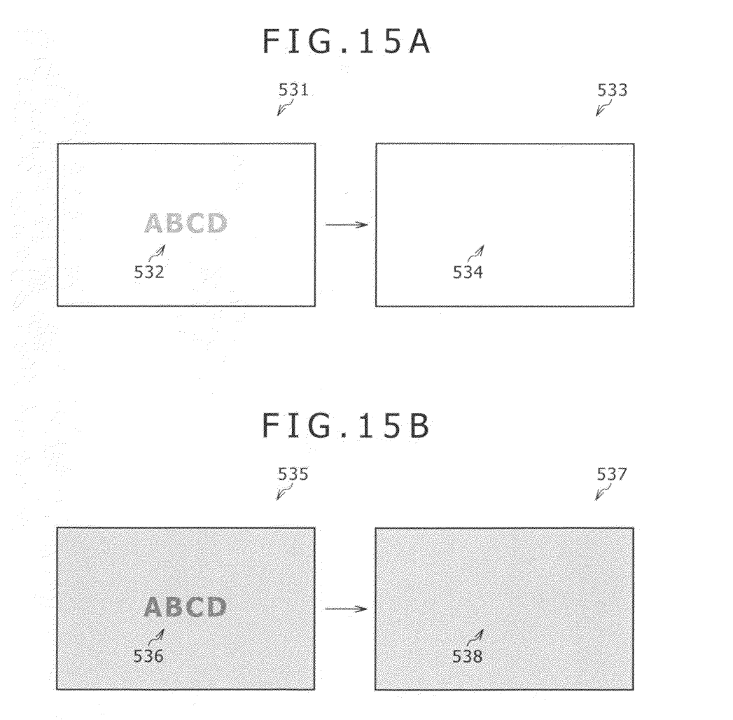

FIGS. 15A and 15B illustrate a concept of effects of correction of an image signal by the first embodiment of the present invention. Here, a difference in effect of correction in the case where only correction of degradation of the conversion efficiency described hereinabove with reference to FIGS. 8A and 8B is carried out is described.

FIG. 15A illustrates an effect of correction in the case where an image signal of a high gradation is supplied in the first embodiment of the present invention. Referring to FIG. 15A, a display screen image 531 is similar to the display screen image 831 shown in FIG. 8A; a ghosting display region 532 is similar to the ghosting display region 832; a display screen image 533 is similar to the display screen image 833; and a ghosting display region 534 is similar to the ghosting display region 834. Accordingly, overlapping detailed description of the displays is omitted herein to avoid redundancy.

FIG. 15A illustrates a manner in which, in the case where an image signal of a high gradation is corrected similarly as in FIG. 8A, the luminance of emitted light from a pixel circuit which suffers much from degradation and the luminance of emitted light from a pixel circuit which suffers little from degradation are corrected so as to be equal to the luminance of a pixel circuit in the initial state.

FIG. 15B illustrates an effect of correction in the case where an image signal of a low gradation is supplied in the first embodiment of the present invention. A display screen image 535 in FIG. 15B is similar to the display screen image 835 in FIG. 8B; a ghosting display region 536 is similar to the ghosting display region 836; and a display screen image 537 is similar to the display screen image 837. Accordingly, overlapping detailed description of the displays is omitted herein to avoid redundancy.

A ghosting display region 538 represents a region corresponding to the position of a pixel circuit with which ghosting occurs on the display screen image 837 similarly to the ghosting display region 838 shown in FIG. 8B. However, a manner can be recognized that this ghosting display region 538 is different from the ghosting display region 838 in that the luminance of emitted light from a pixel circuit which suffers much from degradation is corrected so as to be equal to the luminance of a pixel circuit in the initial state and consequently becomes equal to the luminance of emitted light from a pixel circuit which suffers little from degradation.

In this manner, since the luminance of emitted light from a pixel circuit which suffers from degradation is corrected with a high degree of accuracy so as to be equal to the luminance of emitted light from a pixel circuit in the initial state, ghosting can be eliminated with a high degree of accuracy.

### Example of Operation of the Ghosting Correction Section

Now, operation of the ghosting correction section 200 in the first embodiment of the present invention is described with reference to the drawings.

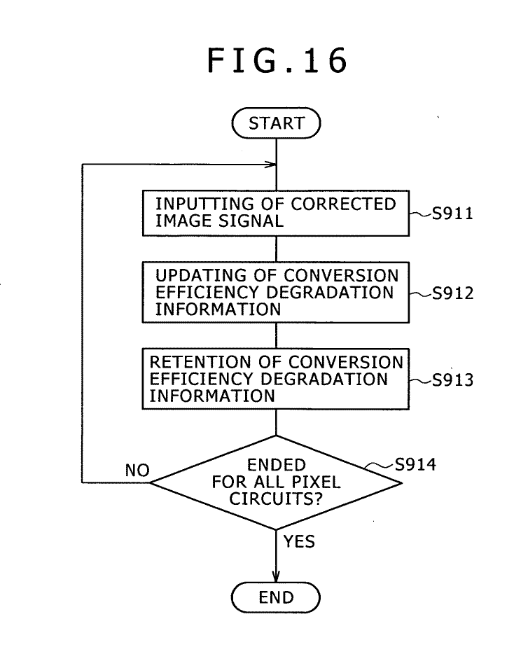

FIG. 16 illustrates an example of an updating processing procedure of conversion efficiency degradation information by the conversion efficiency degradation information integration unit 220 of the ghosting correction section 200 in the first embodiment of the present invention.

First, an image signal corrected by the correction calculation unit 340 is inputted to the conversion efficiency degradation information updating section 221 at step S911. Then, conversion efficiency degradation information is produced by the conversion efficiency degradation information updating section 221 based on the image signal at step S912. Then, conversion efficiency degradation information retained in the conversion efficiency degradation information retaining section 222 is updated at step S913. In particular, the conversion efficiency degradation information is updated by retaining the conversion efficiency degradation information produced by the conversion efficiency degradation information updating section 221 into the conversion efficiency degradation information retaining section 222.

Thereafter, it is decided at step S914 whether or not the conversion efficiency degradation information is updated regarding all of the pixel circuits which configure the displaying screen. Then, if it is decided that the conversion efficiency degradation information is not updated regarding all of the pixel circuits, then the processing returns to step S911 to carry out the updating process of the conversion efficiency degradation information regarding some pixel circuits whose conversion efficiency degradation information is not updated as yet.

On the other hand, if it is decided at step S914 that the conversion efficiency degradation information is updated regarding all of the pixel circuits which configure the displaying screen, then the updating process of the conversion efficiency degradation information by the conversion efficiency degradation information integration unit 220 is ended.

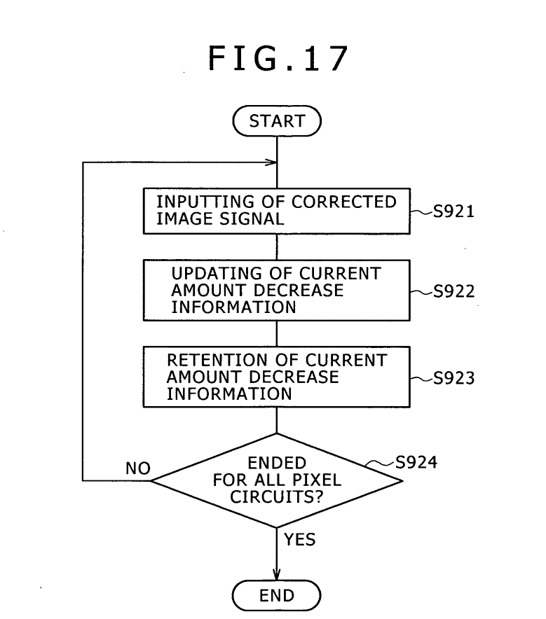

FIG. 17 illustrates an example of an updating processing procedure of the current amount decrease information by the current amount decrease information integration unit 320 of the ghosting correction section 200 in the first embodiment of the present invention.

First, an image signal corrected by the correction calculation unit 340 is inputted to the current amount decrease information updating section 321 at step S921. Then, current amount decrease information is produced by the current amount decrease information updating section 321 based on the image signal at step S922. Then, the current amount decrease information retained by the current amount decrease information retaining section 322 is updated at step S923. In particular, the current amount decrease information is updated by retaining the current amount decrease information produced by the current amount decrease information updating section 321 into the current amount decrease information retaining section 322.

Thereafter, it is decided at step S924 whether or not the current amount decrease information is updated regarding all of the pixel circuits which configure the display screen. Then, if it is decided that the current amount decrease information is not updated regarding all of the pixel circuits, then the processing returns to step S921 to carry out the updating process of the current amount decrease information regarding some pixel circuit whose current amount decrease information is not updated as yet.

On the other hand, if it is decided at step S924 that the current amount decrease information is updated regarding all of the pixel circuits which configure the display screen, then the updating, process of the current amount decrease information by the current amount decrease information integration unit 320 is ended.

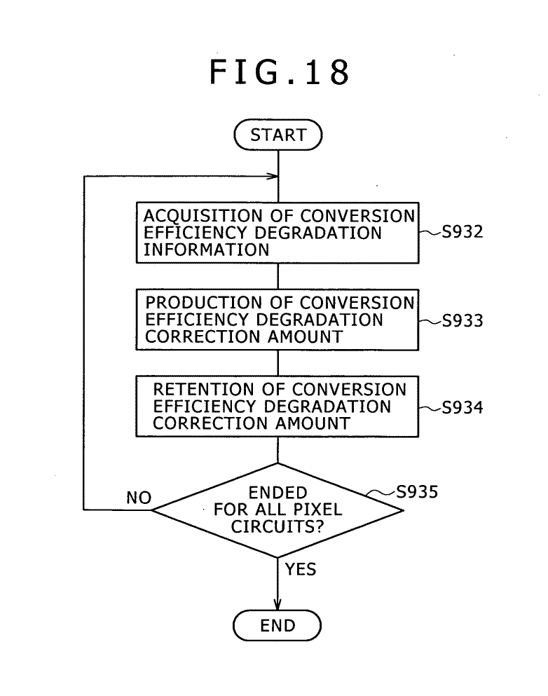

FIG. 18 illustrates an example of a production processing procedure of a conversion efficiency degradation correction pattern by the conversion efficiency degradation correction pattern production unit 230 of the ghosting correction section 200 in the first embodiment of the present invention.

First, at step S932, conversion efficiency degradation information of a pixel circuit of a production target of a conversion efficiency degradation value is acquired by the target conversion efficiency value production section 232 from within the conversion efficiency degradation information retained in the conversion efficiency degradation information retaining section 222. Upon the acquisition of the conversion efficiency degradation information, a target conversion efficiency value is produced from the acquired conversion efficiency degradation information by the target conversion efficiency value production section 232.

Then, at step S933, a conversion efficiency degradation value is produced by the conversion efficiency degradation value calculation section 233 based on a reference conversion efficiency value and the target conversion efficiency value. Then, the produced conversion efficiency degradation value is retained into the conversion efficiency degradation correction pattern retaining section 234 at step S934. It is to be noted that the processing at step S933 is an example of a conversion efficiency degradation value calculation procedure.

Thereafter, it is decided at step S935 whether or not the conversion efficiency degradation value is produced regarding all of the pixel circuits which configure the displaying screen. Then, if it is decided that the conversion efficiency degradation value is not produced regarding all of the pixel circuits, then the processing returns to step S932 to carry out the production process of some conversion efficiency degradation value which is not produced as yet.

On the other hand, if it is decided at step S935 that the conversion efficiency degradation value is produced regarding all of the pixel circuits which configure the displaying screen and the conversion efficiency degradation correction pattern is retained, then the production process of the conversion efficiency degradation correction pattern by the conversion efficiency degradation correction pattern production unit 230 is ended.

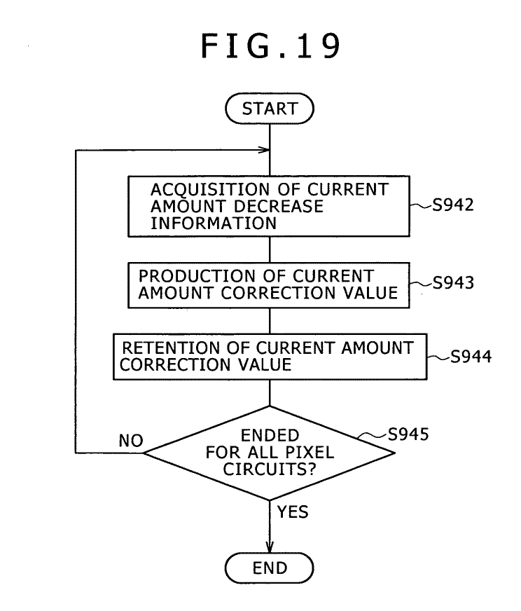

FIG. 19 illustrates an example of a production processing procedure of a current amount decrease correction pattern by the current amount decrease correction pattern production unit 330 of the ghosting correction section 200 in the first embodiment of the present invention.

First, at step S942, current amount decrease information of a pixel circuit of a production target of a current amount degradation value is acquired by the target current amount decrease value production section 332 from within the current amount decrease information retained in the current amount decrease information retaining section 322. Upon the acquisition of the current amount decrease information, a target current amount decrease value is produced from the acquired current amount decrease information by the target current amount decrease value production section 332.

Then, a current amount degradation value is produced based on the target current amount decrease value by the current amount degradation value calculation section 333 at step S943. Then, the produced current amount degradation value is retained by the current amount decrease correction pattern retaining section 334 at step S944. It is to be noted that the process at step S943 is an example of a current amount degradation value calculation procedure.

Thereafter, it is decided at step S945 whether or not the current amount degradation value is produced regarding all of the pixel circuits which configure the displaying screen. Then, if it is decided that the current amount degradation value is not produced regarding all of the pixel circuits, then the processing returns to step S942 to carry out the production process of the current amount degradation value of some pixel circuit whose current amount degradation value is not produced as yet.

On the other hand, if it is decided at step S945 that the current amount degradation value is produced regarding all of the pixel circuits which configure the displaying screen and the current amount decrease correction pattern is retained, then the production process of the current amount decrease correction pattern by the current amount decrease correction pattern production unit 330 is ended.

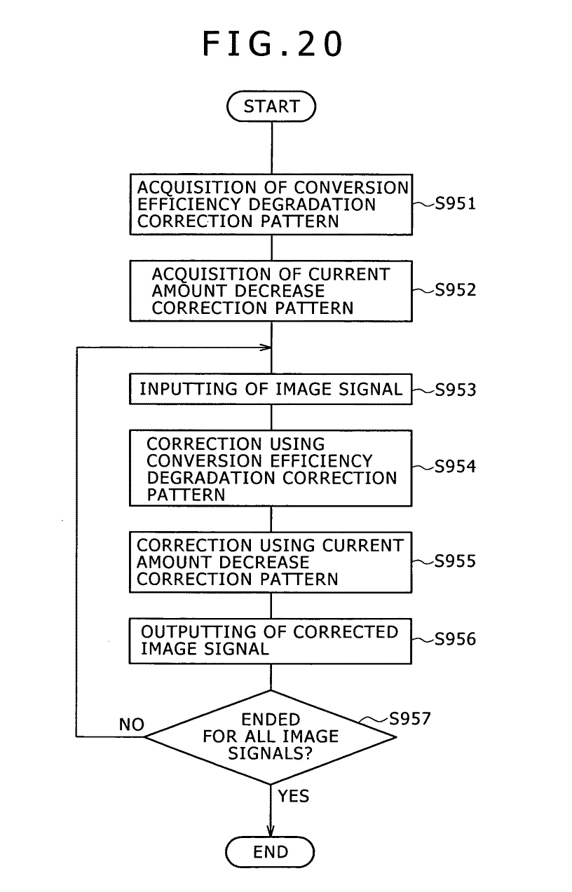

FIG. 20 illustrates an example of a correction processing procedure of an image signal by the correction calculation unit 340 of the ghosting correction section 200 in the first embodiment of the present invention. In the present example, an example of a correction process of an image signal regarding one frame is described.

First, at step S951, a conversion efficiency degradation correction pattern retained in the conversion efficiency degradation correction pattern retaining section 234 is acquired by the conversion efficiency degradation correction calculation section 341. Then, a current amount decrease correction pattern retained in the current amount decrease correction pattern retaining section 334 is acquired by the current amount degradation correction calculation section 342 at step S952.

Then, an image signal is inputted to the conversion efficiency degradation correction calculation section 341 through the signal line 301 at step S953. Then at step S954, by the conversion efficiency degradation correction calculation section 341, correction of the image signal is carried out for each of the pixel circuits using the conversion efficiency degradation value in the conversion efficiency degradation correction pattern. Thereafter, at step S955, correction of the image signal is carried out by the current amount degradation correction calculation section 342 using the current amount degradation value of the pixel circuit which displays the image signal in the current amount decrease correction pattern. Then, the corrected image signal is outputted at step S956. It is to be noted that the processes at step S954 and S955 are an example of a correction procedure.

Thereafter, it is decided at step S957 whether or not all of the image signals which configure one frame to be displayed are corrected). Then, if it is decided that the image signal is not corrected regarding all of the pixel circuits, then the processing returns to step S953 to carry out the correction process of an image signal which is not corrected as yet.

On the other hand, if it is decided at step S957 the image signal regarding all of the pixel circuits which configure one frame to be displayed is corrected, then the correction process of the image signal by the correction calculation unit 340 is ended.

In this manner, with the first embodiment of the present invention, the gradation value of the image signal can be changed with high accuracy so that the luminance of emitted light from a degraded pixel circuit coincides with the luminance of emitted light from a pixel circuit in the initial state. Consequently, correction of ghosting can be carried out with high accuracy for an image signal of any gradation value.

It is to be noted that, while the first embodiment is described taking a pixel circuit in an initial state as a reference, also a method is available wherein correction of ghosting is carried out using a degraded pixel circuit as a reference.

It is to be noted that the display apparatus according to the first embodiment of the present invention can be applied to a display unit, which has a shape of a flat panel, for various electronic apparatus such as, for example, a digital camera, a notebook type personal computer, a portable telephone set, a video camera and so forth. Further, the display apparatus according to the first embodiment can be applied to a display unit of an electronic apparatus in any field wherein an image signal inputted to the electronic apparatus or an image signal produced by the electronic apparatus is displayed as an image. Examples of an electronic apparatus to which such a display apparatus as described above is applied are described below.

### 2. Application Examples of the Invention

### Application Examples to Electronic Apparatus

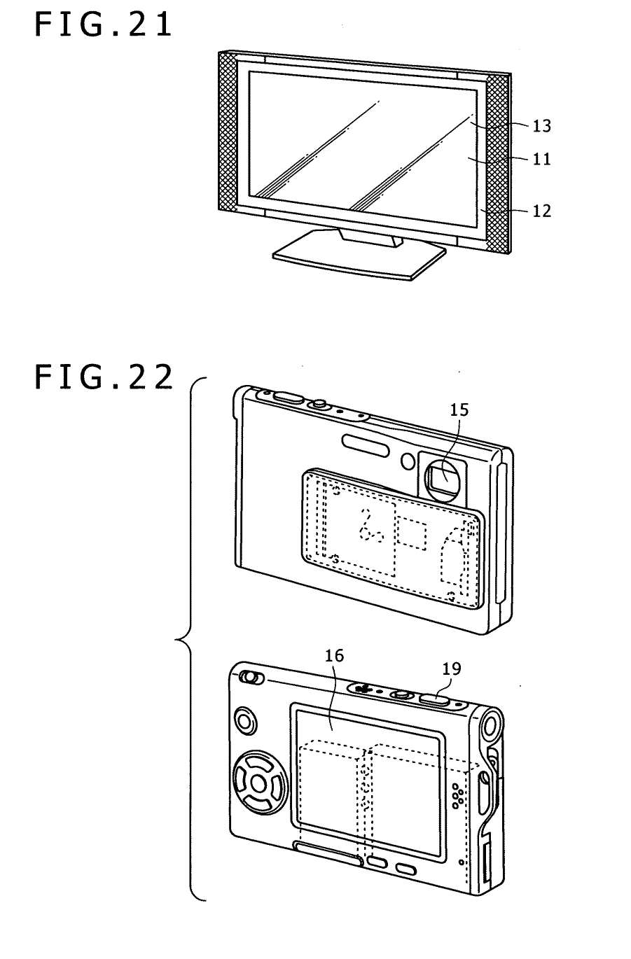

FIG. 21 shows an example of application of the embodiment of the present invention to a television set. To the television set, the first embodiment of the present invention is applied. Referring to FIG. 21, the television set includes an image display screen 11 configured from a front panel 12, a glass filter 13 and so forth and is produced by applying the display apparatus 100 according to the embodiment of the present invention to the video displaying screen 11.

FIG. 22 shows an example of application of the embodiment of the present invention to a digital still camera. To the digital still camera, the first embodiment of the present invention is applied. Referring to FIG. 22, a front elevational view of the digital still camera is shown in the upper stage and a rear elevational view of the digital still camera is shown in the lower stage. The digital still camera includes an image pickup lens 15, a display section 16, control switches, a menu switch, a shutter 19 and so forth and is produced by applying the display apparatus 100 according to the embodiment of the present invention to the displaying section 16.

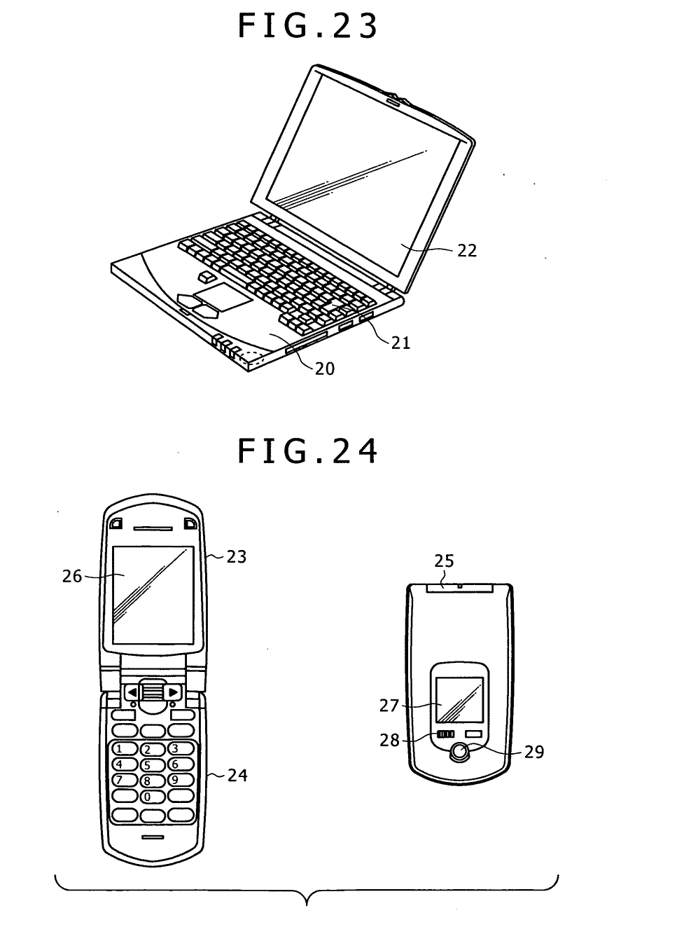

FIG. 23 shows an example of application of the embodiment of the present invention to a notebook type personal computer. To the notebook type personal computer, the first embodiment of the present invention is applied. Referring to FIG. 23, the notebook type personal computer includes a keyboard 21 provided on a main body 20 thereof and operated when characters are to be inputted and a display section 22 provided on a main body cover thereof for displaying an image, and is produced by applying the display apparatus 100 according to the embodiment of the present invention to the display section 22.

FIG. 24 shows an example of application of the embodiment of the present invention to a portable terminal apparatus. To the portable terminal apparatus, the first embodiment of the present invention is applied. Referring to FIG. 24, the portable terminal apparatus is shown in an unfolded state on the left side while it is shown in a folded state on the right side. The portable terminal apparatus includes an upper side housing 23, a lower side housing 24, a connecting section 25 in the form of a hinge, a display unit 26, a sub display unit 27, a picture light 28, a camera 29 and so forth. The portable terminal apparatus is produced by applying the display apparatus 100 according to the embodiment of the present invention to the display unit 26 and/or the sub display unit 27.

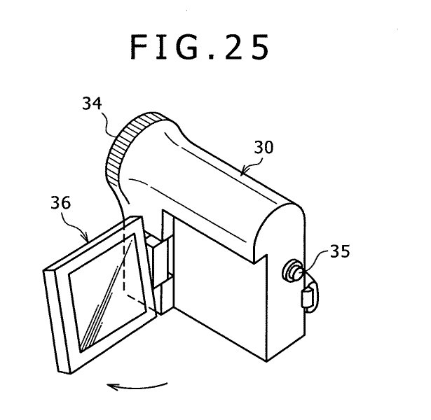

FIG. 25 shows an example of application of the embodiment of the present invention to a video camera. To the video camera, the first embodiment of the present invention is applied. Referring to FIG. 25, the video camera includes a main body section 30, a lens 34 for image pickup of an image pickup object provided on a face of the main body section 30 directed forwardly, start/stop switch 35 for image pickup, a monitor 36 and so forth. The video camera is produced by applying the display apparatus 100 according to the embodiment of the present invention to the monitor 36.

In this manner, with the embodiments of the present invention, ghosting can be eliminated with a high degree of accuracy by carrying out correction regarding decrease of driving current and correction regarding degradation of the conversion efficiency separately from each other.

It is to be noted that the embodiments of the present invention described above are mere examples for embodying the present invention, and various features of the embodiments of the present invention described hereinabove individually have a corresponding relationship to features described in the claims. Similarly, the features described in the claims have a corresponding relationship to features of the embodiments of the present invention represented by like terms. However, the present invention is not limited to the embodiments but can be carried out in various forms by modifying the embodiments without departing from the subject matter of the present invention.

Further, the processing procedures described in the description of the embodiments of the present invention may be grasped as a method which includes the processing procedures. Further, they may be implemented as a program for causing a computer to execute them or a recording medium which stores the program. The recording medium may be, for example, a CD (Compact Disc), an MD (Mini Disc), a DVD (Digital Versatile Disk), a memory card, a blu-ray disc (Blu-Ray Disc: registered trademark) or a like medium.

The present application contains subject matter related to that disclosed in Japanese Priority Patent Application JP 2010-004603 filed in the Japan Patent Office on Jan. 13, 2010, the entire content of which is hereby incorporated by reference.

It should be understood by those skilled in the art that various modifications, combinations, sub-combinations and alterations may occur depending on design requirements and other factor in so far as they are within the scope of the appended claims or the equivalents thereof.

What is claimed is:

1. A signal processing apparatus, comprising:
a conversion efficiency degradation value calculation section adapted to calculate a conversion efficiency degradation value regarding degradation of a conversion efficiency when driving current supplied to a light emitting element in each of a plurality of pixel circuits is converted into a luminance based on information regarding degradation of the conversion efficiency produced in response to lapse of light emission time of the light emitting element;
a current amount degradation value calculation section adapted to calculate a current amount degradation value regarding degradation of the driving current based on information regarding degradation of the driving current produced in response to lapse of the light emission time of the light emitting element; and
a correction section adapted to correct a gradation value of an image signal to be inputted to the pixel circuit based on the conversion efficiency degradation value and the current amount degradation value.

2. The signal processing apparatus according to claim 1, wherein said current amount degradation value calculation section calculates the current amount degradation value of each of the pixel circuits based on the elapsed time of the light emission by the pixel circuit and a gradation value of the image signal in the elapsed time.

3. The signal processing apparatus according to claim 1, further comprising a current amount degradation information retaining section adapted to retain information which is information regarding degradation of the driving current supplied to the light emitting element and is successively added in response to lapse of the light emission time of the light emitting element as current amount degradation information in a unit of a pixel circuit;
said current amount degradation value calculation section calculating the current amount degradation value in a unit of a pixel circuit based on a relationship between the current amount degradation information of that one of the pixel circuits which is a correction target and the current amount degradation information of the pixel circuit which is in an initial state and does not suffer from degradation of the driving current from within the current amount degradation information retained by said current amount degradation information retaining section.

4. The signal processing apparatus according to claim 1, further comprising a conversion efficiency degradation information retaining section adapted to retain information which is information regarding degradation of the conversion efficiency of the driving current supplied to the light emitting element and is successively added in response to lapse of the light emission time of the light emitting element as the conversion efficiency degradation information in a unit of a pixel circuit;
said conversion efficiency degradation value calculation section calculating the conversion efficiency degradation value in a unit of a pixel circuit based on a relationship between the conversion efficiency degradation information of that one the pixel circuits which is a correction target and the conversion efficiency degradation information of the pixel circuit which is in an initial state and does not suffer from degradation of the conversion efficiency from within the conversion efficiency degradation information retained by said conversion efficiency degradation information retaining section.

5. The signal processing apparatus according to claim 1, further comprising a current amount degradation information retaining section adapted to retain information which is information regarding degradation of the driving current supplied to the light emitting element and is successively added in response to lapse of the light emission time of the light emitting element as the current amount degradation information in a unit of a pixel circuit;
said current amount degradation value calculation section calculating the current amount degradation value in a unit of a pixel circuit based on a relationship between the current amount degradation information of that one of the pixel circuits which is a correction target and the current amount degradation information of another one of the pixel circuits which is used as a reference from within the current amount degradation information retained by said current amount degradation information retaining section.

6. The signal processing apparatus according to claim 5, wherein the pixel circuits configure a display screen and the pixel circuit used as the reference is that one of the pixel circuits which exhibits greatest degradation of the driving current.

7. The signal processing apparatus according to claim 1, further comprising a conversion efficiency degradation information retaining section adapted to retain information which is information regarding degradation of the conversion efficiency of the driving current supplied to the light emitting element and is successively added in response to lapse of the light emission time of the light emitting element as the conversion efficiency degradation information in a unit of a pixel circuit;
said conversion efficiency degradation value calculation section calculating the conversion efficiency degradation value in a unit of a pixel circuit based on a relationship between the conversion efficiency degradation information of that one of the pixel circuits which is a correction target and the conversion efficiency degradation information of another one of the pixel circuits which is used as a reference from within the conversion efficiency degradation information retained by said conversion efficiency degradation information retaining section.

8. A display apparatus, comprising:
a signal processing circuit adapted to correct a gradation value of an image signal; and
a plurality of pixel circuits each including a light emitting element which receives driving current corresponding to the image signal supplied thereto and emits light in a luminance corresponding to the driving current;
said signal processing circuit including
a conversion efficiency degradation value calculation adapted to calculate a conversion efficiency degradation value regarding degradation of a conversion efficiency when the driving current supplied to the light emitting element is converted into the luminance based on information regarding degradation of the conversion efficiency produced in response to lapse of light emission time of the light emitting element,
a current amount degradation value calculation section adapted to calculate a current amount degradation value regarding degradation of the driving current based on information regarding degradation of the driving current produced in response to lapse of the light emission time of the light emitting element, and
a correction section adapted to correct the gradation value of the image signal to be inputted to each of said pixel circuits based on the current amount degradation value and the conversion efficiency degradation value.

9. An electronic apparatus, comprising:
a signal processing circuit adapted to correct a gradation value of an image signal; and
a plurality of pixel circuits each including a light emitting element which receives driving current corresponding to the image signal supplied thereto and emits light in a luminance corresponding to the driving current;
said signal processing circuit including
a conversion efficiency degradation value calculation adapted to calculate a conversion efficiency degradation value regarding degradation of a conversion efficiency when the driving current supplied to the light emitting element is converted into the luminance based on information regarding degradation of the conversion efficiency produced in response to lapse of light emission time of the light emitting element,
a current amount degradation value calculation section adapted to calculate a current amount degradation value regarding degradation of the driving current based on information regarding degradation of the driving current produced in response to lapse of the light emission time of the light emitting element, and
a correction section adapted to correct the gradation value of the image signal to be inputted to each of said pixel circuits based on the current amount degradation value and the conversion efficiency degradation value.

10. A signal processing method, comprising the steps of:
calculating a conversion efficiency degradation value regarding degradation of a conversion efficiency when driving current supplied to a light emitting element in a pixel circuit is converted into a luminance based on information regarding degradation of the conversion efficiency produced in response to lapse of light emission time of the light emitting element;
calculating a current amount degradation value regarding degradation of the driving current based on information regarding degradation of the driving current produced in response to lapse of the light emission time of the light emitting element; and
correcting a gradation value of an image signal to be inputted to the pixel circuit based on the current amount degradation value and the conversion efficiency degradation value.

11. A program for causing a computer to execute:
a conversion efficiency degradation value calculation step of calculating a conversion efficiency degradation value regarding degradation of a conversion efficiency when driving current supplied to a light emitting element in a pixel circuit is converted into a luminance based on information regarding degradation of the conversion efficiency produced in response to lapse of light emission time of the light emitting element;
a current amount degradation value calculation step of calculating a current amount degradation value regarding degradation of the driving current based on information regarding degradation of the driving current produced in response to lapse of the light emission time of the light emitting element; and
a correction step of correcting a gradation value of an image signal to be inputted to the pixel circuit based on the current amount degradation value and the conversion efficiency degradation value.

12. A signal processing apparatus, comprising:
conversion efficiency degradation value calculation means for calculating a conversion efficiency degradation value regarding degradation of a conversion efficiency when driving current supplied to a light emitting element in each of a plurality of pixel circuits is converted into a luminance based on information regarding degradation of the conversion efficiency produced in response to lapse of light emission time of the light emitting element;
current amount degradation value calculation means for calculating a current amount degradation value regarding degradation of the driving current based on information regarding degradation of the driving current produced in response to lapse of the light emission time of the light emitting element; and
correction means for correcting a gradation value of an image signal to be inputted to the pixel circuit based on the conversion efficiency degradation value and the current amount degradation value.
